(19) United States
(12) Patent Application Publication
(10) Pub. No.: US 2026/0260556 A1
(43) Pub. Date: Sep. 3, 2026

(54) PERSONAL TRACKING DEVICE

(71) Applicant: IOWISE TECHNOLOGIES, INC., AUSTIN, TX (US)

(72) Inventors: Douglas SCHULZ, Houston, TX (US); Thomas STITH, Houston, TX (US)

(21) Appl. No.: 18/841,668

(22) PCT Filed: Feb. 26, 2023
(86) PCT No.: PCT/IB2023/051779

§ 371 Date: Aug. 26, 2024

Related U.S. Application Data
(60) Provisional application No. 63/268,641, filed on Feb. 28, 2022.

(51) Int. Cl. G08B 21/22; G08B 7/06; G08B 25/10; H04W 4/02; H04W 4/029; H04W 4/80

(52) U.S. Cl. CPC G08B 21/22; G08B 7/06; G08B 25/10; H04W 4/027; H04W 4/029; H04W 4/80

(57) ABSTRACT

This disclosure describes an apparatus and method of an embodiment of an invention that is personal tracking device. This embodiment of the apparatus includes circuitry that includes a processor, memory, location circuity, wireless and/or wired communication circuitry, power supply, user interface; a housing that incorporates the circuitry; a strap with an integrated locking mechanism that couples to the housing.

In addition, this disclosure describes an apparatus and method of an embodiment of an invention that is a system for a personal tracking device. This embodiment of the system includes a personal tracking device in communication with one or more tracking servers; where the personal tracking device can determine its location and status and communicate both to the tracking servers; where the personal tracking device includes: circuitry that includes a processor, memory, location circuity, wireless and/or wired communication circuitry, power supply, user interface; a housing that incorporates the circuitry; a strap with an integrated locking mechanism that couples to the housing.

### CROSS REFERENCE TO RELATED APPLICATIONS

This application claims priority and the benefits of the earlier filed Provisional Application U.S. Application No. 63/268,641, filed Feb. 28, 2022, which is incorporated by reference for all purposes into this specification.

### TECHNICAL FIELD

This disclosure relates to personal tracking devices.

### BACKGROUND ART

Jails and prisons pose significant problems to local, state, and federal governments. Incarcerating offenders requires specialized facilities, trained security personnel, significant infrastructure to feed and clothe the offenders, and expensive medical care, leading to significant cost. Attempts to control such costs, such as through privatization, has led to allegations of profiteering and criticism of living conditions and overcrowding.

Moreover, in recent times, infectious disease has become an issue in such facilities. Even prior to COVID, viruses, bacteria, and sexually transmitted diseases were endemic to incarcerated populations. With the advent of COVID, such issues with infectious disease are exacerbated.

As such, governments are turning to alternative methods to incarceration. For example, our governments are turning to house arrest or ankle monitors for nonviolent offenders. However, conventional ankle monitors have issues relating to location detection, data integrity, tampering, or providing sufficient warning of violations.

This application is related to USAN. 29792035, filed Feb. 28, 2022, which is incorporated by reference for all purposes into this specification and is included as an Appendix to this application.

### SUMMARY OF INVENTION

This disclosure describes an apparatus and method of an embodiment of an invention that is personal tracking device. This embodiment of the apparatus includes circuitry that includes a processor, memory, location circuity, wireless and/or wired communication circuitry, power supply, user interface; a housing that incorporates the circuitry; a strap with an integrated locking mechanism that couples to the housing.

In addition, this disclosure describes an apparatus and method of an embodiment of an invention that is personal tracking device. This embodiment of the apparatus includes means for using circuitry for a personal tracking device; providing a housing that incorporates the circuitry means; providing a strap with an integrated locking mechanism that couples to the housing.

This disclosure describes an apparatus and method of an embodiment of an invention that is a system for a personal tracking device. This embodiment of the system includes a personal tracking device in communication with one or more tracking servers; where the personal tracking device can determine its location and status and communicate both to the tracking servers; where the personal tracking device includes: circuitry that includes a processor, memory, location circuity, wireless and/or wired communication circuitry, power supply, user interface; a housing that incorporates the circuitry; a strap with an integrated locking mechanism that couples to the housing.

In addition, this disclosure describes an apparatus and method of an embodiment of an invention that is personal tracking device. This embodiment of the apparatus includes a personal tracking device in communication with one or more tracking servers; where the personal tracking device can determine its location and status and communicate both to the tracking servers; where the personal tracking device includes: means for using circuitry for a personal tracking device; a housing that incorporates the circuitry; a strap with an integrated locking mechanism that couples to the housing.

The present disclosure further describes an apparatus and method of an embodiment of the invention as further described in this disclosure. Other and further aspects and features of the disclosure will be evident from reading the following detailed description of the embodiments, which should illustrate, not limit, the present disclosure.

In addition, this disclosure describes an apparatus and method of an embodiment of an invention that is an ankle monitoring device that includes a base that houses computational circuitry; communication circuitry in communication with the computational circuitry, the communication circuitry including a cellular data network circuitry; location circuitry in communication with computational circuitry, the location circuitry including global positioning system (GPS) circuitry and one or more accelerometers; and a detection circuitry in communication with the computational circuitry. The ankle monitoring device further includes a strap to engage the base and in electrical communication with the detection circuitry.

This disclosure further describes an apparatus and method of an embodiment of an invention that is a tracking system that includes a tracking server in communication with a network in communication with a cellular data network and an electronic ankle monitor. The electronic ankle monitor includes a base that houses computational circuitry; communication circuitry in communication with the computational circuitry, the communication circuitry in communication with the tracking server through the cellular data network; location circuitry in communication with computational circuitry, the location circuitry including global positioning system (GPS) circuitry and one or more accelerometers; and a detection circuitry in communication with the computational circuitry; and includes a strap to engage the base and in electrical communication with the detection circuitry. The tracking server is in communication with a smartphone application implemented on a smartphone via the cellular data network, the smartphone application associated with a wearer of the electronic ankle monitor.

In addition, This disclosure describes an apparatus and method of an embodiment of an invention that is a method of tracking an individual using an electronic ankle monitor that includes determining a location with a location circuitry using a combination of global positioning system signals and accelerometer signals; comparing, using an ankle monitor computational circuitry, the location to a set of geographical boundaries stored on the ankle monitor; and alerting the individual of a violation of a boundary based at least in part on the comparing.

This disclosure further describes an apparatus and method of an embodiment of an invention that is a method for tracking an individual that includes establish communication between smartphone application and tracking server; communicate a location of the smartphone to the tracking server; and randomly requiring the individual to perform a check-in utilizing facial recognition through the smartphone application.

### BRIEF DESCRIPTION OF DRAWINGS

The drawings accompanying and forming part of this specification are included to depict certain aspects of the disclosure. A clearer impression of the disclosure, and of the components and operation of systems provided with the disclosure, will become more readily apparent by referring to the exemplary, and therefore non-limiting, embodiments illustrated in the drawings, where identical reference numerals designate the same components. Note that the features illustrated in the drawings are not necessarily drawn to scale. The following is a brief description of the accompanying drawings:

FIG. 1 includes an illustration of an example network for tracking a wearable monitor.

FIG. 2 includes an illustration of an example tracking system.

FIG. 3 includes an illustration of an example wearable monitor circuitry.

FIG. 4, FIG. 5, and FIG. 6 include illustrations of an example wearable monitor.

FIG. 7 and FIG. 8 include illustrations of an example wearable monitor and charging device.

FIG. 9, FIG. 10, FIG. 11, and FIG. 12 include illustrations of example straps for use with a wearable monitor.

FIG. 13 includes an illustration of an example securities circuit for use within a strap.

FIG. 14 includes an illustration of an example lock pin of a strap.

FIG. 15, FIG. 16, and FIG. 17 include illustrations of an example base unit of the wearable monitor.

FIG. 18 includes an exploded view of an example base unit.

FIG. 19 includes an exploded view illustration of an example locking mechanism for use within a wearable monitor.

FIG. 20 includes illustration of the lock mechanism.

FIG. 21 includes a cross-section illustration of an example locking mechanism.

FIG. 22 includes an illustration of an example lock nut.

FIG. 23 includes an example of a lock pin.

FIG. 24 includes an illustration of an example cap for use with the lock pin.

FIG. 25 includes an illustration of an example key for use with the lock pin.

FIG. 26 includes illustration of an example charging unit.

FIG. 27 includes a cross-section illustration of an example charging unit.

FIG. 28 includes an illustration of example boundaries for use in the tracking system.

FIG. 29 includes a block flow diagram of a method for applying a wearable monitor.

FIG. 30 and FIG. 31 include a block flow diagram illustrating example methods for monitoring a wearer.

FIG. 32 includes a block flow diagram illustrating a method for providing alerts based upon location information of the wearable monitor.

FIG. 33-FIG. 42 include illustrations of example interfaces of a tracking application.

FIG. 43-FIG. 50 include illustrations of example interfaces of a smartphone application.

The use of the same reference symbols in different drawings indicates similar or identical items.

### DESCRIPTION OF EMBODIMENTS

The disclosed embodiments should describe aspects of the disclosure in sufficient detail to enable a person of ordinary skill in the art to practice the invention. Other embodiments may be utilized, and changes may be made without departing from the disclosure. The following detailed description is not to be taken in a limiting sense, and the present invention is defined only by the included claims.

Specific implementations shown and described are only examples and should not be construed as the only way to implement or partition the present disclosure into functional elements unless specified otherwise in this disclosure. A person of ordinary skill in the art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Benefits, other advantages, and solutions to problems are shown and described with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In the following description, elements, circuits, and functions may be shown in block diagram form in order not to obscure the present disclosure in unnecessary detail. And block definitions and partitioning of logic between various blocks are exemplary of a specific implementation. It will be readily apparent to a person of ordinary skill in the art that the present disclosure may be practiced by numerous other partitioning solutions. A person of ordinary skill in the art would understand that information and signals may be represented using any of a variety of technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, where the bus may have a variety of bit widths and the present disclosure may be implemented on any number of data signals including a single data signal.

The illustrative functional units include logical blocks, modules, and circuits described in the embodiments disclosed in this disclosure to emphasize their implementation independence more particularly. The functional units may be implemented or performed with a general-purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described in this disclosure. A general-purpose processor may be a microprocessor, any conventional processor, controller, microcontroller, or state machine. A general-purpose processor may be considered a special purpose processor while the general-purpose processor is configured to fetch and execute instructions (e.g., software code) stored on a computer-readable medium such as any type of memory, storage, and/or storage devices. A processor may also be implemented as a combination of computing devices, such as a combination of a DSP and a microprocessor, a plurality of microprocessors, one or more microprocessors in conjunction with a DSP core, or any other such configuration.

In addition, the illustrative functional units described above may include software or programs such as computer readable instructions that may be described in terms of a process that may be depicted as a flowchart, a flow diagram, a structure diagram, or a block diagram. The process may describe operational acts as a sequential process, many acts can be performed in another sequence, in parallel, or substantially concurrently. Further, the order of the acts may be rearranged. In addition, the software may comprise one or more objects, agents, threads, lines of code, subroutines, separate software applications, two or more lines of code or other suitable software structures operating in one or more software applications or on one or more processors. The software may be distributed over several code segments, modules, among different programs, and across several memory devices. Similarly, operational data may be identified and illustrated in this disclosure within modules and may be embodied in any suitable form and organized within any suitable data structure. The operational data may be collected as a single data set or may be distributed over different locations including over different storage devices. Data stated in ranges include each and every value within that range.

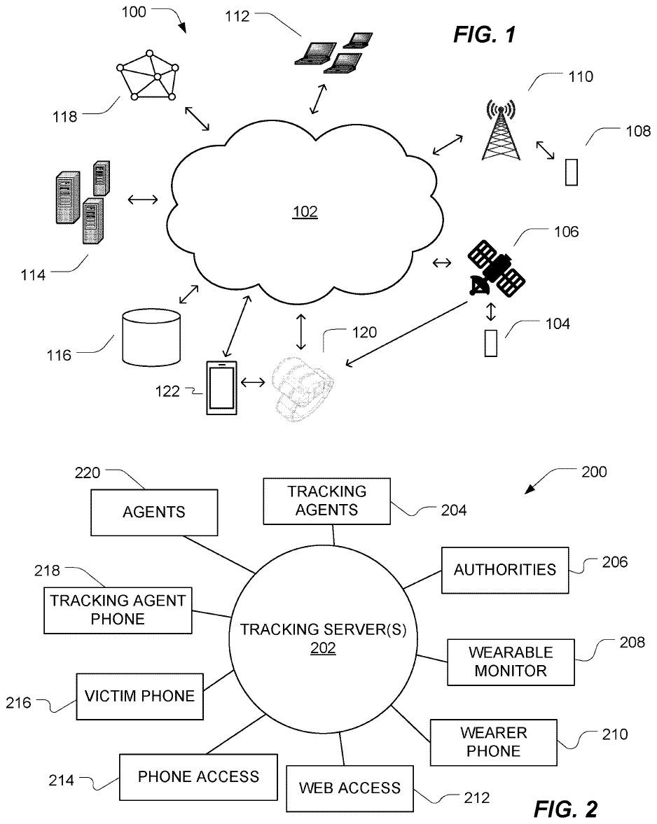

Elements described in this disclosure may include multiple instances of the same element. These elements may be generically indicated by a numerical designator (e.g., 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most discussed. For example, where feasible elements in FIG. 1 are designated with a format of 1xx, where 1 indicates FIG. 1 and xx designates the unique element.

Any reference to an element in this disclosure using a designation such as “first,” “second,” and so forth does not limit the quantity or order of those elements, unless such limitation is explicitly stated. Rather, these designations may be used in this disclosure as a convenient method of distinguishing between two or more elements or instances of an element. A reference to a first and second element does not mean that only two elements may be employed or that the first element must precede the second element. In addition, unless stated otherwise, a set of elements may comprise one or more elements.

Reference throughout this specification to “one embodiment”, “an embodiment” or similar language means that a particular feature, structure, or characteristic described in the embodiment is included in at least one embodiment of the present invention. Appearances of the phrases “one embodiment”, “an embodiment” and similar language throughout this specification may, but do not necessarily, all refer to the same embodiment.

In the following detailed description, reference is made to the illustrations, which form a part of the present disclosure, and in which is shown, by way of illustration, specific embodiments in which the present disclosure may be practiced. These embodiments are described in sufficient detail to enable a person of ordinary skill in the art to practice the present disclosure. However, other embodiments may be utilized, and structural, logical, and electrical changes may be made without departing from the true scope of the present disclosure. The illustrations in this disclosure are not meant to be actual views of any particular device or system but are merely idealized representations employed to describe embodiments of the present disclosure. And the illustrations presented are not necessarily drawn to scale. And elements common between drawings may retain the same or have similar numerical designations.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the present disclosure should be determined by the following claims and their legal equivalents.

As used in this disclosure, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Furthermore, the term “or” as used in this disclosure is generally intended to mean “and/or” unless otherwise indicated. For example, a condition A or B is satisfied by any one of the following: A is true (or present) and B is false (or not present); A is false (or not present) and B is true (or present); and both A and B are true (or present). As used in this disclosure, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description in this disclosure, the meaning of “in” includes “in” and “on” unless the context clearly dictates otherwise.

To aid any Patent Office and any readers of any patent issued on this disclosure in interpreting the included claims, the Applicant(s) wish to note that they do not intend any of the appended claims or claim elements to invoke 35 U.S.C. 112(f) unless the words “means for” or “step for” are explicitly used in that claim. Additionally, if any elements are specifically recited in means-plus-function format, then those elements are intended to be construed to cover the corresponding structure, material, or acts described in this disclosure or additional equivalents in accordance with 35 U.S.C. 112(f).

In an embodiment, a tracking system includes a wearable monitor or a personal tracking device in communication with one or more tracking servers. The wearable monitor or personal tracking device, such as an ankle monitor, can include a base that houses electronics for identifying a location of the wearer and for storing such location information and can include a strap to secure the monitor to a wearer. Optionally, the wearable monitor may store location boundary information and compare location boundary information to the location of the wearer. The tracking system may further communicate with one or more cell phone applications, agent computers, authority servers, or databases, among others.

FIG. 1 includes an illustration of an example network 102 in communication with a wearable monitor 120, such as an electronic ankle monitor. The wearable monitor 120 can determine a location of a wearer and communicate the location through the network 102 to a set of tracking servers 114. In an example, the wearable monitor 120 can determine location based on global positioning systems, triangulation of cell towers, proximity to wireless networks, proximity to or in communication with a cell phone or smartphone 122, such as through Bluetooth®, or accelerometers, among others. In an example, the wearable monitor 120 can be in communication with a wearer's cell phone 122, such as through a wireless connection, for example Bluetooth® or Wi-Fi. The wearable monitor 120 can be in communication with the network using wireless protocols, such as a cell phone data network, for example, a broadband cellular network. In another example, a wearable monitor 120 can be in communication with the network 102 through Wi-Fi, SMS, satellite communications, Bluetooth®, or through proprietary methods.

The system 100 can include one or more tracking servers 114 that receive location information and optionally, other status information from the wearable device 120 or the wearer cell phone 122. The one or more tracking servers 114 can be in communication with databases 116 to store location data or information about the wearer or the wearable device 120. Further, the one or more tracking servers 114 can be in communication with an immutable storage system 118, such as a block chain storage system. In a particular example, the tracking servers 114 can implement a web-based interface or application, permitting setup, monitoring, and disconnection of a wearable monitor 120.

The one or more tracking servers 114 can be in communication with other computers 112, for example, used by agents to set up and track the wearable device 120 or authorities to monitor compliance. For example, agents can set up and track devices through a web-based application implemented on the tracking servers 114.

The one or more tracking servers 114 can be in communication with other mobile devices 108 through, for example, a cellular data network 110. In an example, other mobile devices can include devices of tracking agents, victims, or authorities. In addition, the one or more tracking servers 114 can be in communication with mobile devices 104 through satellite networks 106. For example, smartphone applications in communication with the tracking servers 114 can be implemented on smartphones associated with victims, agents, or authorities.

In general, the wearable monitor 120 communicates directly with the network 102. Alternatively, the wearable monitor can communicate with the mobile device 122, which in turn communicates with the network 102. For example, the mobile device 122 can include an application that monitors the performance of the wearable monitor 120 and transmits such information through the network 102 to the one or more tracking servers. In an example, the mobile device 122 is a smartphone implementing a smartphone application. The smartphone application can provide notifications associated with functionality of the device, battery life, upcoming events, or boundary violations, among other functions. The smartphone application can further be used to check the presence of the wearer assigned to the smartphone or electronic ankle monitor, for example, by taking a picture or facial recognition.

FIG. 2 includes an illustration of a tracking system 200 that includes one or more tracking servers 202 in communication with a wearable monitor 208, such as an ankle monitor. Tracking servers 202 can be in communication with agent devices 220. For example, a bail bonds agent or an authority agent can associate a wearable monitor 208 with a wearer. The agent devices 220 can be used to enter information about the offender, payment methods, identification of the wearable monitor, or location boundaries to be associated with the wearable monitor. Optionally, key dates, such as court appearance, dates, bond amounts, next of kin information, addresses, work addresses, victim addresses, cell phone numbers, or identifiers, pictures of the wearer, or state issued identification numbers, among others.

Tracking servers 202 can also be in communication with tracking agent devices 204. For example, once the wearable monitor 208 is in the field being worn by an alleged offender, tracking agents may monitor the location of the offender, or a status of the device. Tracking agents 204 can contact the wearer in the case of a change in status of the device or can contact bond or parole agents in charge of the offender. In the event of boundary violations, the tracking agents 204 can optionally contact authorities based on boundary violations or a change in status of the wearable monitor. For example, the tracking servers 202 can provide a web-based application for accessing and providing information.

In addition, the tracking servers 202 can be in communication with authorities 206. For example, the tracking servers 202 can provide authorities with location information, a history of locations of the wearable monitor, notification of boundary violations, notification of a change in status of the wearable monitor, such as tampering with the device, or information associated with the agents 220.

In another example, the tracking servers 202 can be in communication with a wearer's phone application 210. For example, the tracking servers can communicate with the wearer through the wearer phone application. Such a phone application may provide alerts to a wearer of a change in status of the wearable monitor or a boundary violation. Further, the tracking servers 202 can provide alerts to the phone application 210 regarding key dates for court appearance. In a further example, the tracking servers 202 can permit payment through the wearer's phone application 210. In an additional example, a wearer may utilize the wearer phone application to notify the tracking servers 202 of issues with monitoring the wearable monitor 208, such as issues of discomfort, failure to charge, incorrect readings, or other matters.

In a further example, the tracking servers 202 can provide web access 212. For example, payments can be made through web access 212 or a history of locations can be provided to the wearer. Further, the wearer can make appointments for device maintenance either through the web access 212 or through the wearer's phone application 210.

The alleged offender may further be able to access or attend hearings or other meetings utilizing voice or video conferencing through the wearer's phone application 210 or the web access 212. In another example, the wearer's phone application 210 may permit a wearer to take pictures of themselves and confirm proximity to the wearable monitor 208. For example, the wearable monitor 208 may be in communication with the wearer's phone application through Bluetooth®, such as low energy Bluetooth®. The wearer can take a picture of themselves, and the phone application 210 can confirm proximity to the wearable monitor 208 and provide the picture to provide confirmation to the tracking servers 202. Optionally, the wearer phone application 210 or the tracking servers 202 can use facial recognition to confirm the identity of the alleged offender based on the picture.

Optionally, the tracking servers 202 can provide traditional phone access 214, such as through a landline in a touch tone system. Various services such as taking payments, providing tracking information, providing key dates, or providing other information can be accessed through the phone access 204.

In some circumstances, victims may have the right to know when an alleged offender is in proximity to them. In such a case, the tracking servers 202 may communicate with a victim phone application 216 to indicate whether the alleged offender is in proximity to the victim. The victim phone application 216 may provide the victim with options to change notification methods, test operability of the system, updated personal information, or track key dates associated with the court appearances.

In another example, the tracking servers 202 may communicate with a tracking application of the mobile device 218. For example, if an alleged offender violates boundaries or skips bail, a licensed individual or the authorities may seek to track down the alleged offender and may use such a tracking application 218 on a mobile device. Such tracking application 218 may further permit the licensed individual to contact authorities once the alleged offender has been located and identified. In other examples, such a tracking application may allow the licensed individual to take pictures of the alleged offender or key evidence to provide to authorities to assist with locating and apprehending the alleged offender.

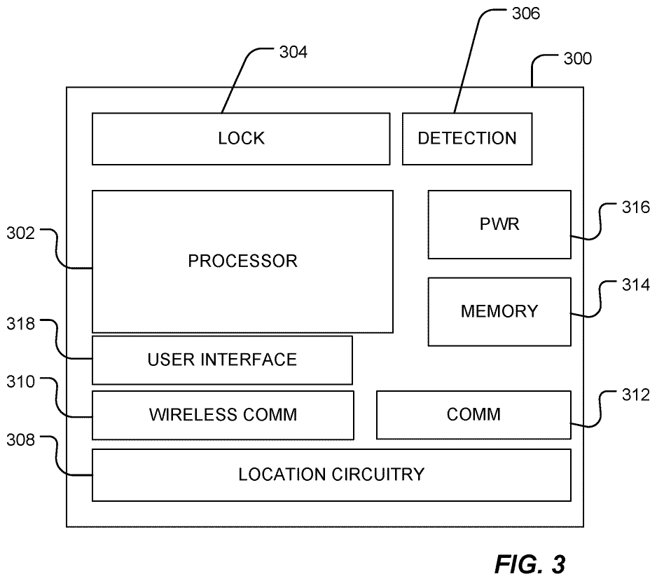

FIG. 3 includes an illustration of example circuitry 300 associated with a wearable monitor. In an example, the circuitry 300 includes a processor 302. The processor 302 can be in communication with a locking mechanism 304 and a detection mechanism 306. For example, the locking mechanism 304 can secure an end of a strap that wraps around an appendage of the wearer to secure the wearable monitor to the wearer. In conjunction with the strap, the detection circuitry 306 can determine whether the strap remains intact or whether tampering has occurred.

The processor 302 is in communication with a location circuitry 308. For example, the location circuitry 308 can determine a location of the wearable monitor. In an example, the location circuitry 308 can use global positioning system circuitry to determine location. In another example, the location circuitry 308 can include accelerometers to determine location. In additional examples, the location circuitry 308 can include triangulation circuitry for determining location based on cell phone networks, Wi-Fi networks, Bluetooth® networks, or other wireless networks. In a particular example, the location circuitry 308 utilizes a global positioning system to determine location and further utilizes accelerometers to determine location if a signal from the global positioning system is lost. Other triangulation circuitry can further be used as backup information to confirm the GPS location or that location determined by the accelerometers.

The processor 302 can be in communication with a wireless communication circuitry 310. In an example, the processor 302 can communicate to tracking servers or to authorities' location information about the wearable monitor, a status of the wearable monitor, such as power levels, tamper detection, strength of signal, or self-diagnostic information. In an example, the wireless communication circuitry 310 permits communication with a broadband cellular data network. In another example, the wireless communication circuitry 310 permits communication using standards such as Bluetooth®, Wi-Fi, SMS, or cellular voice network, among others.

The processor 302 can further be in communication with a wired communication circuitry 312. In an example, the processor 302 may communicate with computers or other equipment using a physical connection through the wired communication circuitry 312. In an example, an agent can utilize a wired connection through the wired communication circuitry 312 to program the processor or download data. In another example, archive data may be uploaded from the wearable device using the wired communication circuitry 312. In an example, the wired communication circuitry 312 can be a serial bus communication circuitry, such as a USB port. In another example, the wired communication circuitry 312 can use Thunderbolt™ or Firewire ™. Alternatively, the wired communication circuitry 312 can utilize a proprietary method.

The processor 302 can further be in communication with a power supply 316, such as a battery or capacitor. In an example, the power supply 316 may be charged with the wired communication circuitry 312, such as using a powered USB port, Thunderbolt™ port, or Firewire™ port.

Further, the processor 302 can be in communication with memory 314. For example, the memory 314 can include instructions operable by the processor 302 to perform the operations of the wearable monitor. In another example, location data can be stored in the memory 314 for later retrieval and communication through the wireless communication circuitry 310 or the wired communication circuitry 312. Further, location boundaries may be stored in the memory 314. Such boundaries can be referenced by the processor 302 and compared to locations determined by the location circuitry 308. In the event of boundary violations, the processor 302 can communicate an alert through the wireless communication circuitry 310 to remote tracking servers. In another example, the processor 302 can communicate violations or status to a user through user interfaces 318.

For example, the user interface 318 can include lights, such as LEDs. In another example, the user interface 318 can include a speaker. Accordingly, the processor 302 may communicate alerts to the wearer of the wearable monitor through visual or auditory signals.

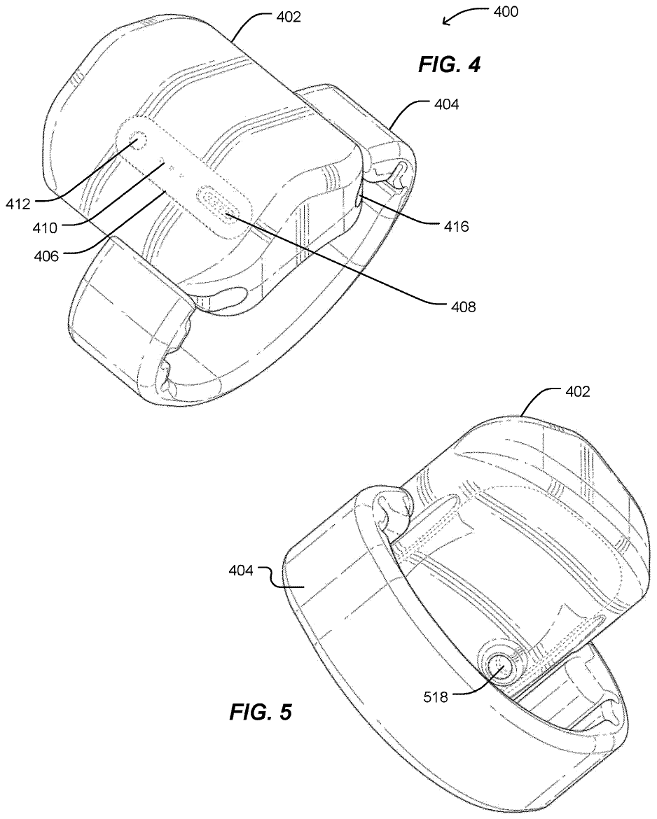

In a particular example, FIG. 4 illustrates a wearable monitor 400, such as an ankle monitor. The wearable monitor 400 may include a base 402 and a strap 404 secured to the base 402. The base 402 can include an interface 406. In an example, the interface 406 includes a charging and data port 408. Further, the interface 406 can include lights 412 and a speaker 410. Lights 412 and the speaker 410 can be utilized to communicate device status or optionally alert a wearer of a violation.

The strap 404 may be secured to the base through guides 414 and 416. When in position within the guides 414 or 416, the strap 404 forms a circuit with the base 402, permitting detection of tampering with the monitor 400.

The strap 404 can be secured at one end using an active lock mechanism. The other end of the strap 404 can be secured using a fixed pin. In an example, the fixed pin is disposed on a side of the base 402 facing the wearer. For example, the fixed pin can be inserted at the hidden interface 518, illustrated in FIG. 5, disposed on a backside or inward facing side of the base 402.

FIG. 6. illustrates a side view of the base 402 and the strap 404. The strap 404 is connected to the base at interfaces 414 or 416. In an example, the strap 404 is secured to the base 402 using the hidden pin interface 518. The strap 404 can be secured to the base 402 through the guide 416 using an active lock can be opened and closed electronically.

In an example, the strap 404 includes pillows 630 and 634 integrated to the strap 404 and separated by valleys 632 or 636. Such pillows can assist with positioning the base 402 away from the skin of the wearer. The valleys 632 and 636 allow for greater flexing of the strap 404 in proximity to the ends of the strap 404. As illustrated, the pillows 630 closer to the interface with the base may be larger than pillows 634.

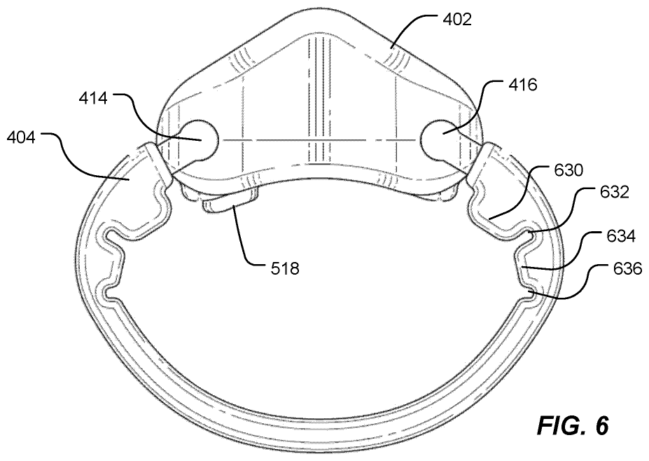

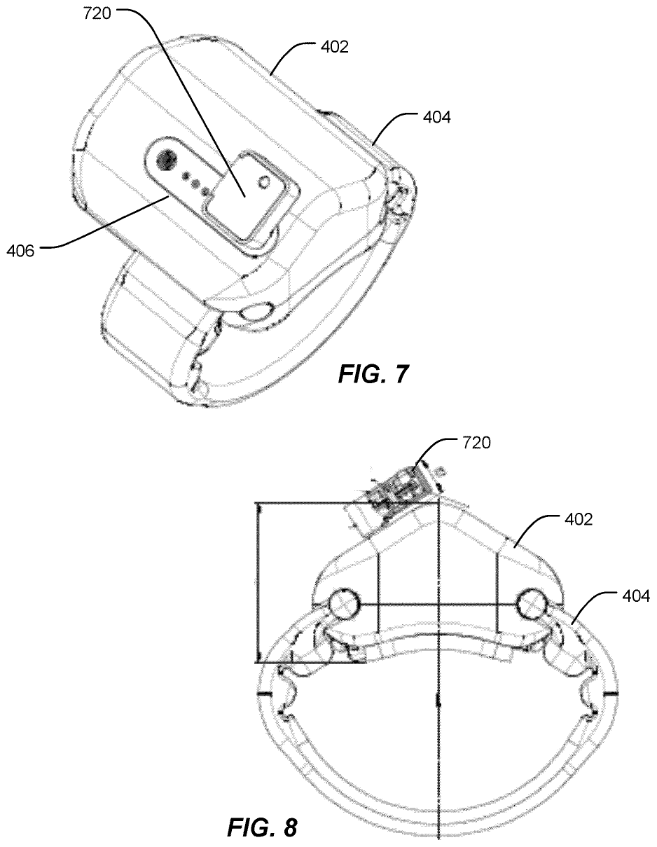

FIG. 7 and FIG. 8 include illustrations of the wearable monitor 400 and a charging device 720. In an example, the charging device 720 connects with the interface 406 of the base 402. The charging device 720 can provide power to the base 402. Further, the charging device 720 can provide data access through the interface 406 on the base 402. As illustrated, the charging device 720 is detachable and optionally, includes magnets to assist with connecting and staying connected to the base 402.

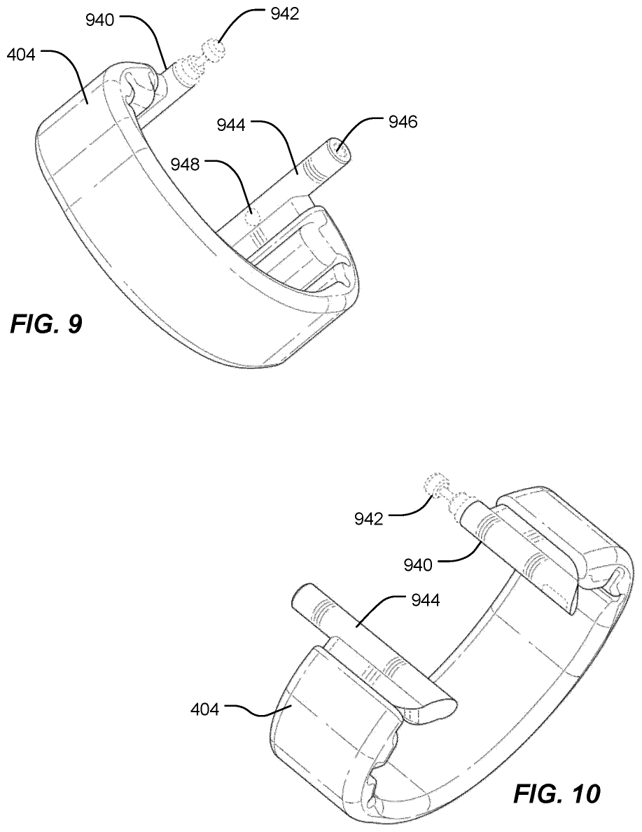

FIG. 9, FIG. 10, FIG. 11, and FIG. 12 include illustrations of an example strap 404. The strap 404 can include a terminal end 940 configured to engage the interface 416 of the base 402. In an example, the terminal end 940 includes a locking pin 942 configured to engage an electromechanical lock at interface 416 of the base 402. The locking pin 942 can be constructed to provide electronic communication between strap 404 and the base 402. The strap 404 can further include a second terminal end 944 to engage the interface 414 of the base 402. The terminal end 944 provides a pad 946 to electronically connect to the base 402. The terminal end 944 may further include an opening 948 to receive a fixed locking pin.

In an example, the terminal ends 940 and 944 provide electronic communication with the base. The strap 404 includes circuitry to ensure integrity of the strap or to detect the integrity of the strap. For example, the strap 404, through the terminal ends 940 and 944, in conjunction with the base 402 define a circuit that if broken, indicates tampering with the wearable monitor. In particular, a circuitry having a serpentine path may be embedded within the strap 404.

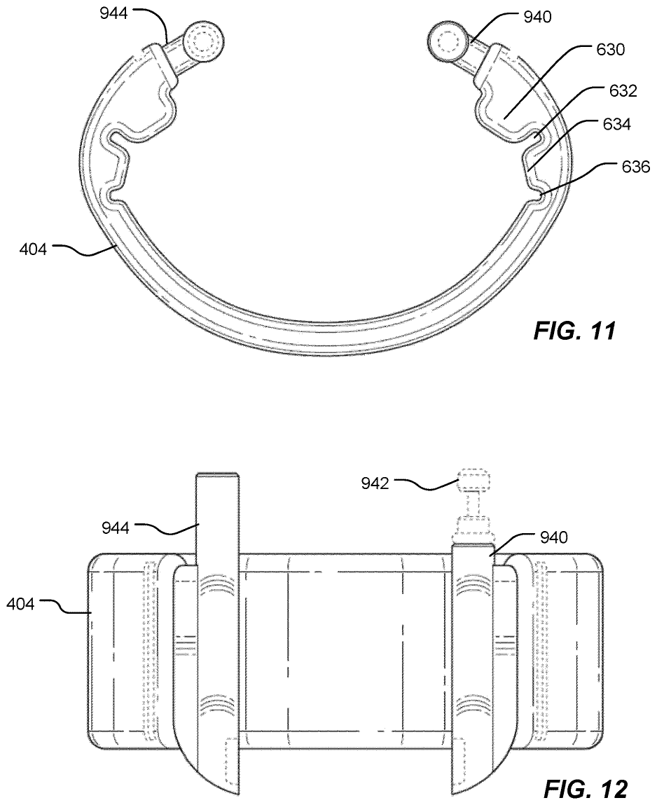

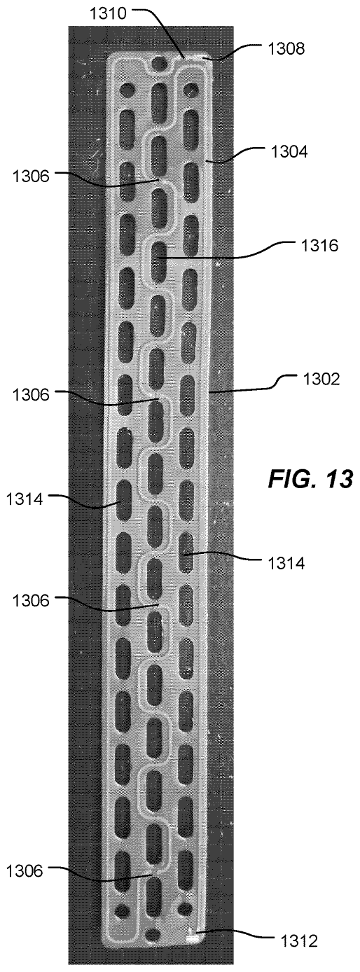

The circuitry can have an expected resistance that when changed indicates tampering with the strap 404. For example, FIG. 13 illustrates an example circuit board 1302, such as a flexible circuit board, to be embedded within the strap 404. The flexible circuit board 1302 includes a conductive path 1304 defined along the flexible circuit board 1302. In an example, the conductive path 1304 is serpentine, passing back and forth and back again across the circuit board 1302. In various locations 1306 along the serpentine path, resistors can be disposed which assist with defining the resistance across the conductive path 1304. At pads 1308 and 1312, the conductive path 1304 can connect with pads or pins to interface with a base which detects the resistance along the conductive path 1304. Optionally, an additional resistor 1310 can be disposed in proximity to one or both of the terminal ends 1308 or 1302 of the conductive path 1304. In a further example, the flexible circuit board 1302 includes openings or 1314 or 1316 to enhance flexibility of the flexible circuit board and to improve adhesion of the over molded strap to the flexible circuit board. One or more openings 1314 or 1316 can be defined within the flexible circuit board 1302.

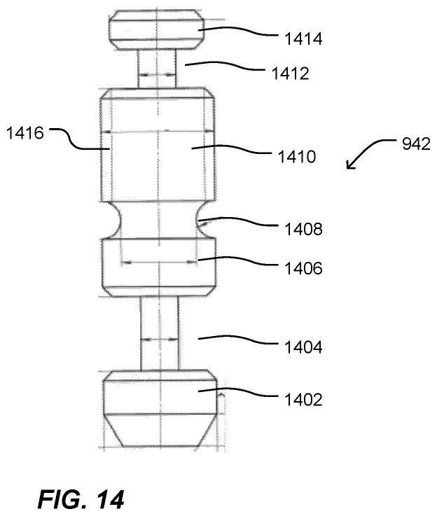

FIG. 14 includes an illustration of an example lock pin 942 of the terminal end of the strap. (940 (404)). In an example, the lock pin 942 is formed of conductive material and interfaces with the conductive circuitry or flexible circuit board 1302 to provide a conductive path to interface with the base 402. In an example, the lock pin 942 includes a head 1402 to provide electrical interface with the base. The lock pin 942 can further include a main body 1416, and a lock recess 1404 disposed between the main body 1416 and the head 1402. The lock recess 1404 can engage a lock nut to secure the lock pin 942 within the interface of the base 402. The main body 1416 can include a lower portion 1406, an upper portion 1410, and a recess 1408 disposed between the lower portion 1406 and the upper portion 1410. Further, the lock pin 942 can include a top 1414 separated from the main body 1416 by a recessed portion 1412. The recess portion 1412 may be utilized to secure the lock pin 942 to the strap 404. Optionally, the lock pin 942 can be connected to the flexible circuit board 1302 through the top 1414 or a portion of the main body 1410.

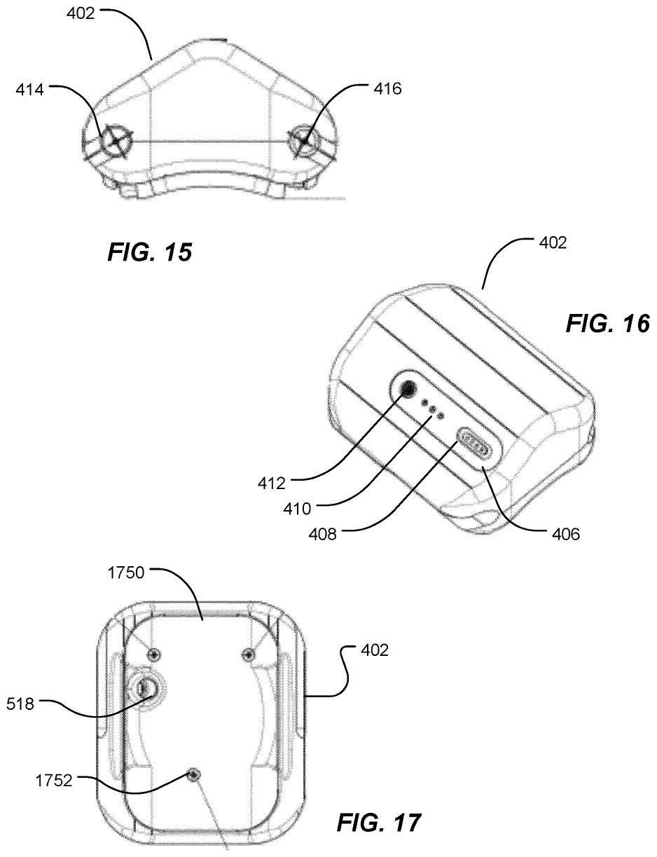

FIG. 15, FIG. 16, and FIG. 17 include illustrations of the base 402 absent the strap 404. The base 402 includes the interfaces 414 and 416 to receive a strap. In addition, the base 402 includes an interface 406, which includes an electronic interface 408, an auditory interface 410, and a visual interface 412. On a back side of the base 402, as illustrated in FIG. 17, a hidden fixed pin interface 518 is disposed through a back cover 1750, secured to the base housing by fasteners 1752.

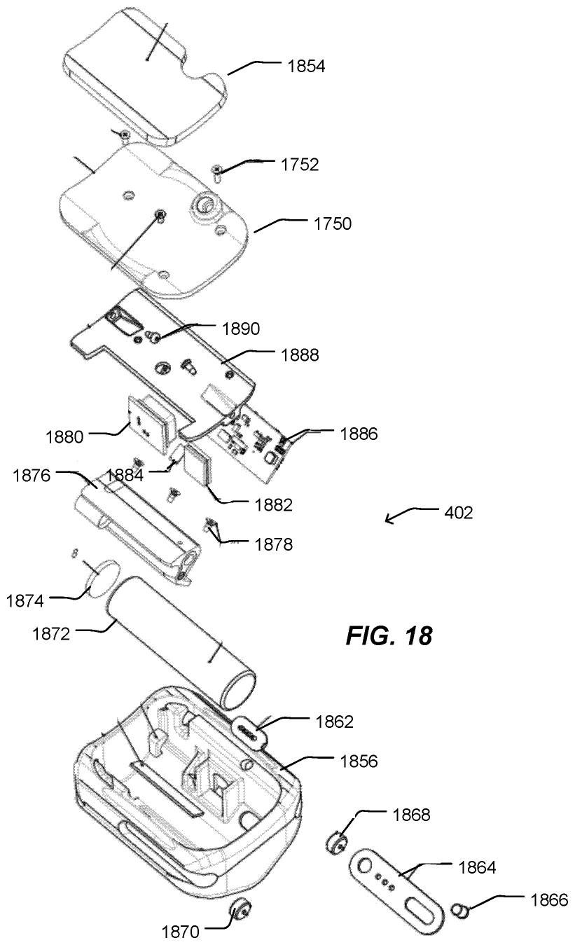

In further detail, FIG. 18 includes an exploded view illustration of components of the base 402. The base 402 can include a housing 1856 which in which various components are secured. For example, a faceplate 1864 can be secured within the housing 1856, and a speaker 1866 can be secured to the base plate 1864. An electronic interface 1862 can be secured through the faceplate 1864. Further, contacts 1870 and 1868 can be supplied within the guides of the housing 1856 to provide an electronic interface with a strap 404. For example, the contacts 1870 and 1868 can be pogo pin contacts.

Housing 1856 can further store a battery 1872 and a pad 1874. The pad can provide electrical contact with the battery 1872 or provide positioning of the battery within the housing 1856.

The housing 1856 can further secure a locking mechanism 1876 to electromechanically engage a strap 404. The locking mechanism 1876 can be secured using one or more fasteners 1878, such as screws, rivets, or pins. Alternatively, the locking mechanism 1876 can be secured within the housing using an adhesive.

The housing 1856 further stores various electronic components. For example, the housing 1856 may secure a main circuit board 1886. In an example, the circuit board 1886 includes an LED's that can project through the faceplate 1864. The main circuit board 1886 can include a processor, memory, and other components of the wearable monitor. In an additional example, the housing 1856 can further store a location detection module 1880. In an example, the location detection module 1880 can be a GPS module. In another example, the module 1880 can include accelerometers. In a further example, the module 1880 can include triangulation circuitry for triangulating position based on wireless signals.

In a further example, the housing 1856 can secure wireless communication module 1882. For example, the wireless communication module 1882 can be a GSM communication module, a Bluetooth® module, a Wi-Fi module, or various other wireless communication modules. The housing 1856 may further secure other circuit boards, such as an adapter circuit board 1884.

The components may be secured in place with a panel 1888 using fasteners 1890. For example, fasteners 1890 can be screws, pins, or rivets. A black back plate 1750 can further be applied to secure the components within the case 1856 and can be secured in place by one or more fasteners 1752, such as screws, pins, or rivets. Optionally, a cushion 1854 can be applied to the back plate 1750.

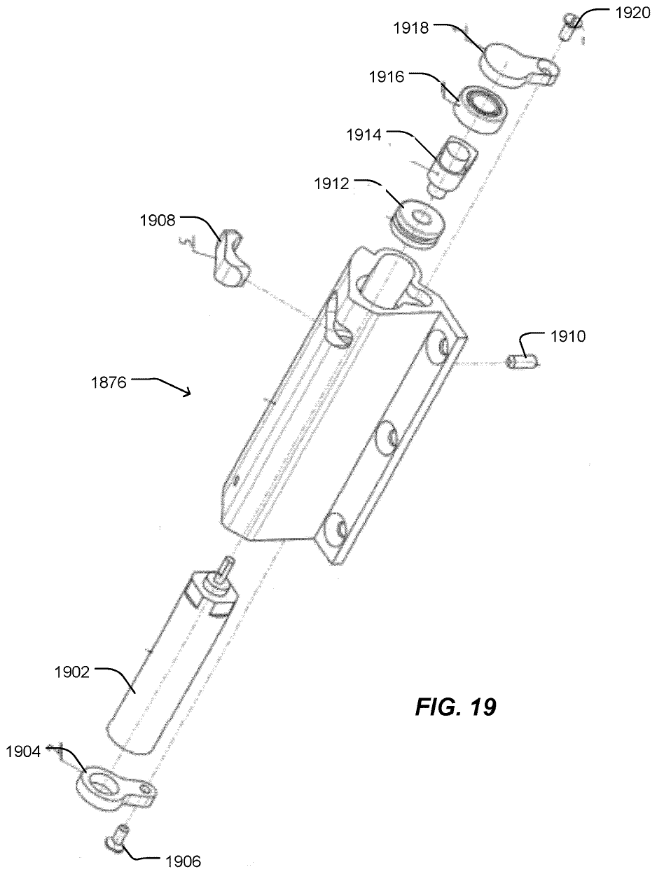

Turning to FIG. 19, a locking mechanism 1876 can house a motor 1902 to move a lock nut 1914 into position to lock or unlock a strap from the base unit. The motor 1902 can be separated from the lock nut by a spacer 1912, which may be compressible. In addition, the lock nut 1914 fits into a washer or bearing 1916 to facilitate axial turning of the lock nut 1914. The components, such as the motor 1902 and the lock nut 1914, can be secured on either end with end caps 1904 or 1918 and secured with respective fasteners, such as fasteners 1906 or 1920, which may be screws, pins, or rivets. The locking mechanism 1876 can further include a pin 1910 to position the motor and prevented it from turning. The locking mechanism 1876 can further include a lock plugged to further support the axial movement of the lock nut 1914.

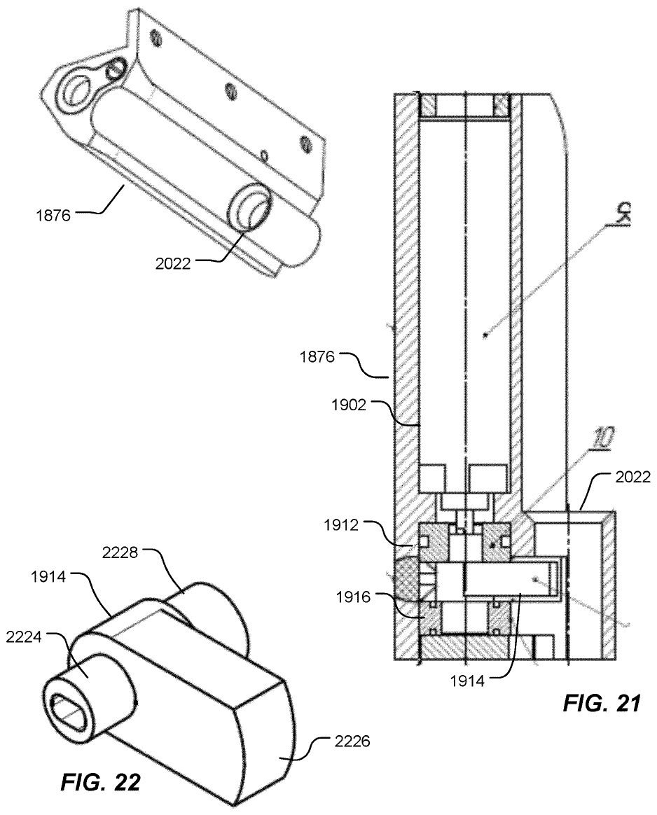

As further illustrated in FIG. 20 and FIG. 21, a locking mechanism provides an interface 2022 to receive the lock pin of the strap 404. The lock nut 1914 can move in and out of position to engage a recess within the lock pin of the strap, securing the strap within the locking mechanism and positioning it against the pogo pin interface to electronically connect the strap with the detection circuitry of the base 402.

The lock nut 1914, as illustrated in FIG. 22, includes an opening 2224 to engage the motor 1902 and includes a distal end 2228 to engage a washer or bearing 1916. A center portion of the lock nut 1914 includes a protrusion 2226 that can be moved in and out of engagement with a lock pin to secure or release the lock pin from the locking mechanism.

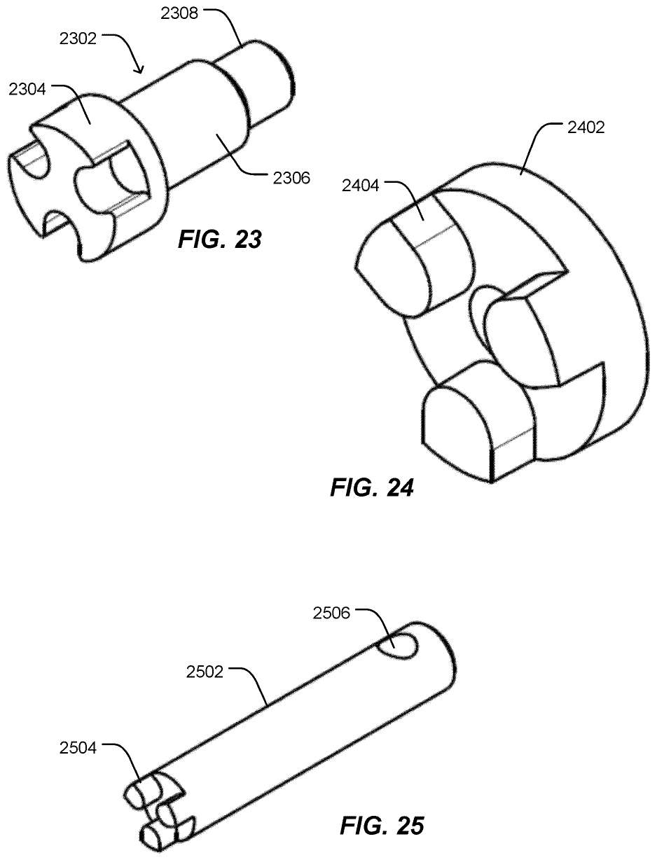

An opposite end of the strap, distal from the end including the lock pin can be secured in place using a fixed mechanism. For example, FIG. 23 illustrates a fixed lock pin 1302, including a portion 2308 that can engage with the strap, a portion 2306 engages with the case, and a keyed portion 2304. In an example, the portions 2308 or 2306 can be threaded to either threadably engage the strap or threadably engage the case. To protect and hide the fixed key, a plug 2402, as illustrated in FIG. 24 can be provided with an interface 2404 that complements the keyed portion 2304 of the fixed lock pen. To engage or disengage the lock pin, a specialty key 2502 illustrated in FIG. 25 can be used. The specialty key has a keyed portion 2504 complementing the pattern of the key portion 2304 of the lock pin 2302 and can include an interface 2506 to receive a bar or rod for leverage.

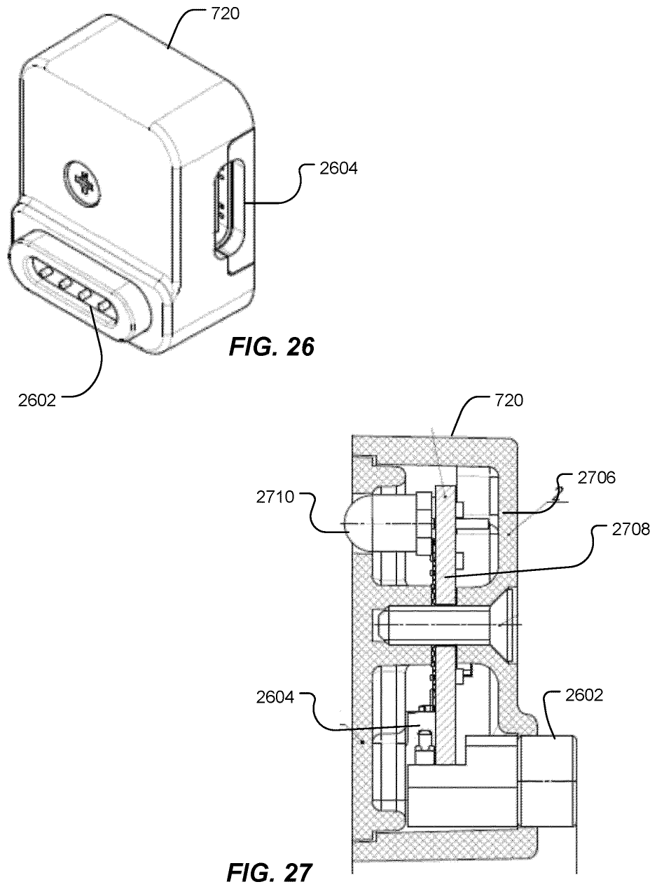

The base 402 can engage with a charging unit 702. In an example illustrated in FIG. 26 and FIG. 27, the charge unit 702 includes an interface 2602 to engage the electronic interface of the base 402. The interface 2602 can provide power. Further, the interface 2602 can provide for data access to the base. In addition, the charging unit can include a port 2604. The port 2604 can receive power from an external source and optionally can be a communications port. For example, the port 2604 can be a USB port, such as a USB-A, B, or C port, a Thunderbolt™ port, or a Firewire™ port. An interface 2602 can be in electronic communication with a circuit board 2708 secured within the housing 2706. In addition, the user interfaces, such as lights or speakers, can be secured to the circuit board 2708. For example, an LED light 2710 can be secured to the circuit board 2708 and can be used to indicate functionality or power status of the device. In another example, it can be used to indicate a boundary violation. In a further example, the wearable monitor can include a kinetic device to communicate through vibration.

The wearable monitor, such as an ankle monitor or bracelet, can be used to track the location of an individual, such as an alleged offender, as an alternative to incarceration. The individual wearer may be assigned a region or area in which they are permitted to be, and as such, boundaries may be defined around that region such that crossing a boundary or being outside of that region represents a violation. In another example, boundaries or regions can be defined within which the individual is not allowed to be, such as in proximity to an individual or location subject to a restraining order. Such boundaries or regions can be stored within a tracking system, and upon receiving a wearer's location, can be compared to the location of the wearer to determine whether a violation is occurring. In another example, such boundaries or regions can be downloaded into the base unit 402 and the monitor can compare the present location of the monitor to the permitted regions or boundaries to determine whether a violation has occurred. If a violation has occurred, the unit can notify the wearer, encouraging them to return to their permitted region. Alternatively, or in addition, the wearable monitor can, in addition to providing location information, provide status alerts to the tracking system which can in turn contact the wearer, contact authorities, or contact victims.

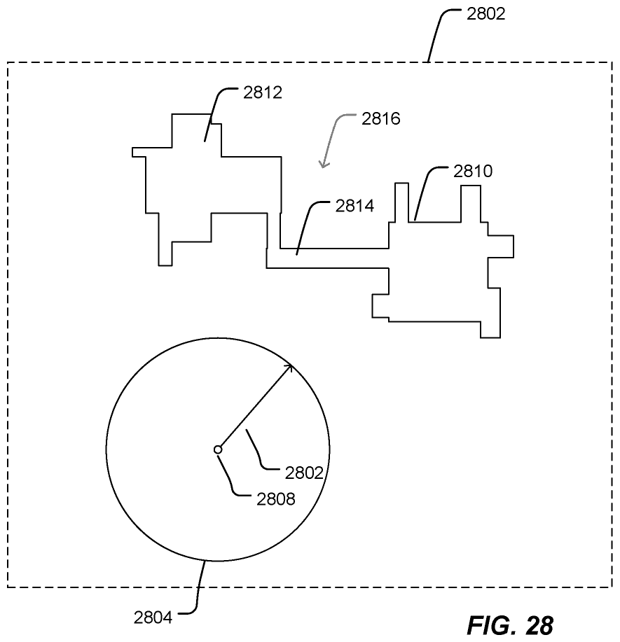

In an example, FIG. 28 represents boundaries and permissible regions to be compared to a wearer's location. For example, over an area 2802, such as a city, regions such as region 2804 or 2816 can be defined. In an example, a region 2804 can be defined based on a radius 2806 from a center point 2808. The region 2804 may represent the permissible region in which the wearer is allowed to be. Alternatively, the region 2804 can represent a region outside of which the wearer is allowed to be or within which the wearer is not allowed to be. For example, a victim can have a restraining order providing boundaries around particular addresses. In another example, a region 2816 can be defined based on access to work, home, or groceries. For example, a region 2810 can be defined around an individual's home based on permissible city blocks on which the individual is allowed to be. A similar region 2812 can be provided around, for example, a workplace. In addition, a corridor or 2814 can be provided between the regions 2810 and 2812 as a permissible path to get between home and work, for example. Such regions tend to be rectilinear and are indicative of city blocks and locations of home, work, and permissible shopping locations. In an example, such regions can be downloaded into the wearable monitor. The wearable monitor can monitor location of the individual to determine whether the wearer is within their permissible region or are within a region within which they are not allowed to be. The wearable monitor can alert the wearer and send location and status information to a tracking system.

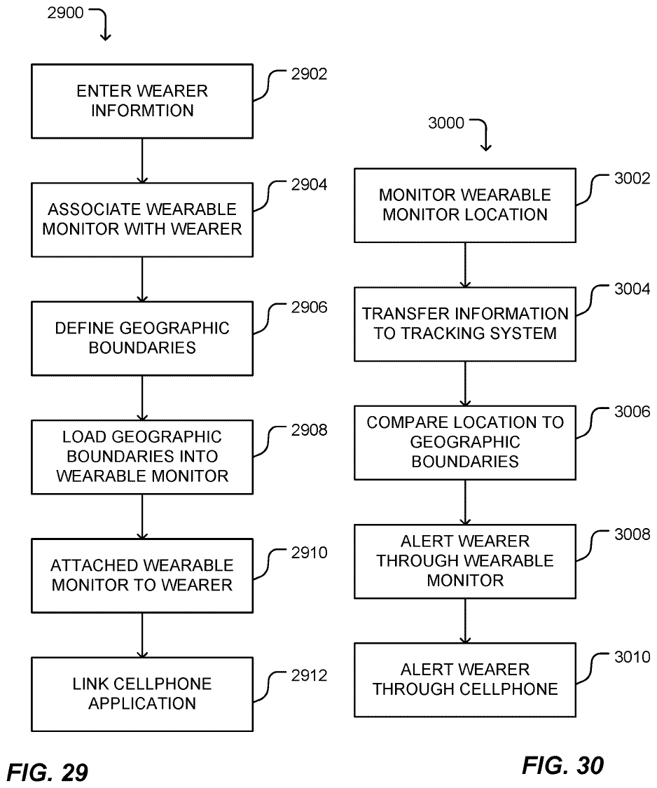

To set up such a tracking system with the wearable monitor, an agent can collect information about the wearer, associate an ankle monitor with the wearer, and provide other initiating information to the ankle monitor before applying the ankle monitor to the wearer. For example, FIG. 29 illustrates a method 2900 for establishing tracking of a wearer. As illustrated at block 2902, the agent can enter wearer information into the tracking system. Wearer information can include a wearer's identity, payment information, address, information about court dates, legal representatives, and alternative contact information.

As illustrated at block 2904, the agent can associate a wearable monitor with the wearer. For example, the agent can associate the identity or network access information for the wearable monitor. For example, when a wearable monitor transmits information to the tracking system, it may provide an identifying code and optionally network address, which can be associated with the wearer.

The agent can further define boundaries, such as boundaries within which the wearer is required to stay or boundaries within which the wearer is not allowed to go. As such, the agent can define the geographic boundaries, as illustrated at block 2906. Such boundaries may be defined by the courts. For example, the court can define boundaries based on a restraining order or based on a jurisdiction. Further, geographical boundaries can be defined based on a radius from a particular location or based on other factors. Such geographical boundaries can be stored within the tracking system and compared to locations received from the wearable monitor. In another example, the geographical boundaries may be loaded into the wearable monitor, as illustrated at block 2908. For example, such boundaries can be loaded either wirelessly or through a wired connection into the base. In an example, the wired interface of an ankle monitor can be used to download boundary data to the wearable monitor.

Once the initial step is complete, the wearable monitor can be attached to the wearer, as illustrated at block 2910. For example, the strap can be wrapped around the wearer's leg and the detachable strap can be inserted into the base. The base can be directed to lock the strap in place using the locking mechanism. Such instruction to lock the locking mechanism can be conducted wirelessly or can be through the wired connection. To remove the wearable monitor, the locking mechanism can be directed to open, allowing the strap to release from the interface of the base.

Optionally, the wearer may have a cell phone that has a cell phone application providing a further means of notifying the wearer, providing the wearer with access to payment systems, and showing the wearer status of the wearable monitor. Optionally, other cell phone application, such as a victim cell phone application can be provided with access through the tracking system of location data or specific alerts tied to the location data.

Once attached, the wearable monitor can monitor the location of the wearer to determine whether violations of boundaries have occurred. For example, as illustrated in FIG. 30, a method 3000 for monitoring a wearable monitor includes monitoring the wearable monitor location, as illustrated at 3002. For example, the wearable monitor may monitor location based on GPS location, accelerometer data, or a combination thereof. In another example, the wearable monitor may monitor location based on triangulation of cell phone signals, Wi-Fi signals, or other wireless signals. In a further example, the wearable monitor can access information on the user's phone to identify location information.

As illustrated at block 3004, the wearable monitor can transfer information to the tracking system. For example, the wearable monitor can transfer the location information. Further, the wearable monitor can transfer status associated with the wearable monitor, such as a status of the security circuit extending through the strap, a power status of the device, operational status of the device, or software errors or component malfunctions, or other information associated with system status. Further, the wearable monitor can transfer alert statuses.

The wearable monitor, if provided with geographic boundaries, can compare the locations to the geographic boundaries, as illustrated at block 3006. For example, the wearable monitor may determine whether the wearer is beyond a fixed distance from a set location or was within a geographic boundary defined by or on the tracking system.

When a wearable monitor is not within the boundaries or has violated one of the boundaries, an alert can be provided to the wearer through the wearable monitor, as illustrated at block 3008. For example, the wearable monitor may provide a sound indicating the violation of a boundary. In another example, the wearable monitor may provide a light indication for visual indication of a violation. Further, the wearable monitor may through a local connection, such as Wi-Fi or Bluetooth®, notify the cell phone application of the wearer to alert the wearer through the cell phone, as illustrated at block 3010. In another example, the wearable monitor provides an alert status to the tracking system. The tracking system then provides an alert to the wearer's cell phone.

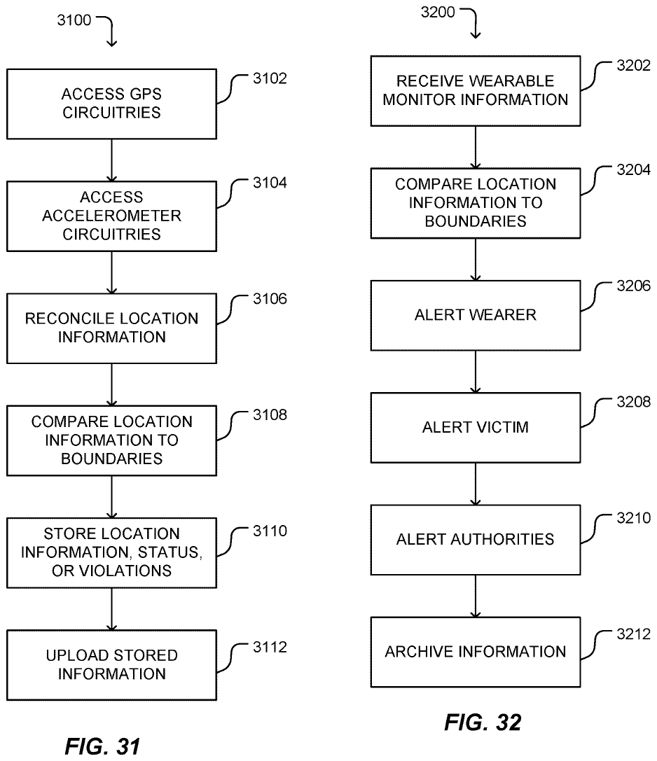

At times, a wearer may pass under a bridge or into a building through which GPS information or access is limited. In such an example, the additional circuitry within the wearable monitor may reconcile location using other methods. For example, as illustrated in FIG. 31, a method for communicating location information includes accessing GPS circuitry, as illustrated in block 3102. The wearable monitor may be in a location at which GPS signals are available. The circuitry can access the signals to determine location.

In addition, accelerometers may be used to further determine position, as illustrated at block 3104. For example, accelerometers can determine location based on movements of the wearable monitor.

Using the combined methods of the GPS circuitry and the accelerometer circuitry, the location can be reconciled, as illustrated in block 3106. For example, GPS location may be lost, and the accelerometer data relied upon to more accurately indicate a location of the person based on last known position using GPS and movements of the wearable monitor following loss of the GPS signal.

Once the location is determined, the location can be compared to geographical boundaries, as illustrated at block 3108. Such boundaries may indicate regions in which the wearer is required to stay or locations the wearer is not allowed to be. The system can determine an alert status based on a comparison of location information and the geographical boundaries. In an example, the alert status can be determined by the wearable monitor. In another example, the alert status can be determined by the tracking server. In a further example, the alert status can be determined by the wearer's smartphone.

As illustrated at block 3110, such information, statuses, or violations can be stored within a memory of the wearable monitor. If a signal is lost to communicate with the tracking servers, the wearable monitor can store location information and status until such time as a network communication is reestablished.

As illustrated in block 3112, stored information can be uploaded when the network is available. For example, the location, history, status, and or violations can be provided to the tracking servers and used to perform various functions at by the tracking servers. For example, the stored information can be uploaded directly to the tracking server when a cellular data network is available. In another example, the stored information can be uploaded to the smartphone and then transmitted to the tracking server.

In an example, the tracking servers may determine status associated with the device and statuses associated with violation boundary violations. As illustrated in FIG. 32, a method 3200 includes receiving the wearable monitor information from the wearable monitor at the tracking server, as illustrated at block 3202. Such information can include device status, location information, or alerts.

The tracking servers can compare the location information to the geographic boundaries associated with the wearer, as illustrated at block 3204. Violations of such boundaries can result in various alerts, such as alerts to the wearer warning of the violation, alerts to victims of a wearer's proximity to the victim, and alerts to authorities should it become necessary to arrest or detain the individual. For example, an alert can be sent to the wearer's email, as illustrated at block 3206. In an example, the wearable monitor can be directed to provide an auditory or visual alert to the wearer through the wearable monitor. In another example, alerts can be sent to a cell phone application associated with the wearer to provide alerts to wearer through a cell phone that a violation has occurred and encouraging compliance boundaries.

Alerts can be sent to victims, as illustrated at block 3208. For example, the alert can be sent to a cell phone application associated with a victim's cell phone to notify them of a violation by the wearer of the wearable monitor.

If the wearer has not complied with the geographical boundaries, alerts can be sent to authorities, as illustrated block 3210. Such alerts can be forwarded to court systems to utilize location history or alert history in determining compliance with court orders. In another example, alerts can be sent to policing authorities encouraging the detainment of the individual.

Further, the tracking servers can archive the information, as illustrated at block 3212. For example, the information can be stored in databases. In particular example, the information can be stored in an immutable block chain storage system.

In an example, the tracking system can be implemented using a tracking server, an electronic ankle monitor, and a smartphone. The tracking server can communicate with the ankle monitor and the smartphone using a cellular data network. For example, the tracking server can be connected to a global data network, such as the Internet, which is connected to various cellular data networks.

In an example, the tracking server implements a web application through which an agent can initiate and monitor the electronic ankle monitor. In addition, the agent can initiate the smartphone application and associate the smartphone and the application with the ankle monitor or the individual to which the electronic ankle monitor is applied.

Initiating the electronic ankle monitor can include activating a locking mechanism, creating a profile associating an individual wearer of the electronic ankle monitor, and establishing payment methods for equipment rental and tracking services. Through the web application, the agent can also disconnect or unlock the electronic ankle monitor, address issues with the ankle monitor, and review status and location of the electronic ankle monitor.

Initiating the smartphone application on the smartphone can include installing the application on the smartphone, associating the phone number of the smartphone with the individual and ankle monitor worn by the individual, or setting up payment methods, among other activities.

The web application can further implement interfaces for authorities, such as parole officers, law enforcement, or the court system. In another example, the web application can include victim information that allows alerts to be sent to a victim. For example, the system can include a second smartphone application coupled with a smartphone associated with a victim. When the wearer of the ankle monitor violates a geographical boundary, such as that of a restraining order, the tracking server can notify the victim through the victim smartphone application. In a further example, the web application can communicate with a smartphone application on smartphones associated with law enforcement or other officers of the court. In such an example, the tracking server can provide information such as location, ankle monitor status, and boundary violations to parole officers, law enforcement officers, or other agents of the court.

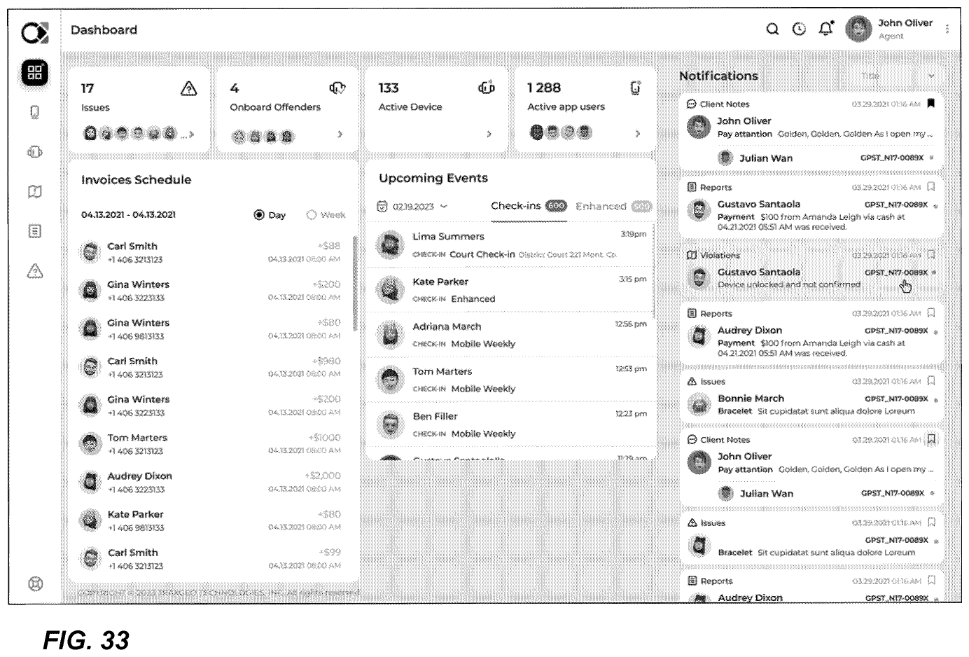

In an exemplary embodiment, the web application on the tracking server can provide an interface to one or more agents, such as a dashboard illustrated in FIG. 33. In the illustrated example, an agent John Oliver can track a group of wearers of electronic ankle monitors. The dashboard can provide notifications of issues associated with the ankle monitors, track active devices, and track users of the smartphone application. In some cases, alleged offenders can be tracked using the cell phone or smartphone application without the use of an ankle monitor.

The dashboard can further provide information regarding upcoming events for each of the wearers of the ankle monitor bracelets or active users of the smartphone application. For example, users of the smartphone application and optionally wears of the ankle monitor are required to check-in periodically using the smartphone application. The user check-in can be required randomly or can be required in association with court dates or other events associated with the wearer's legal restrictions.

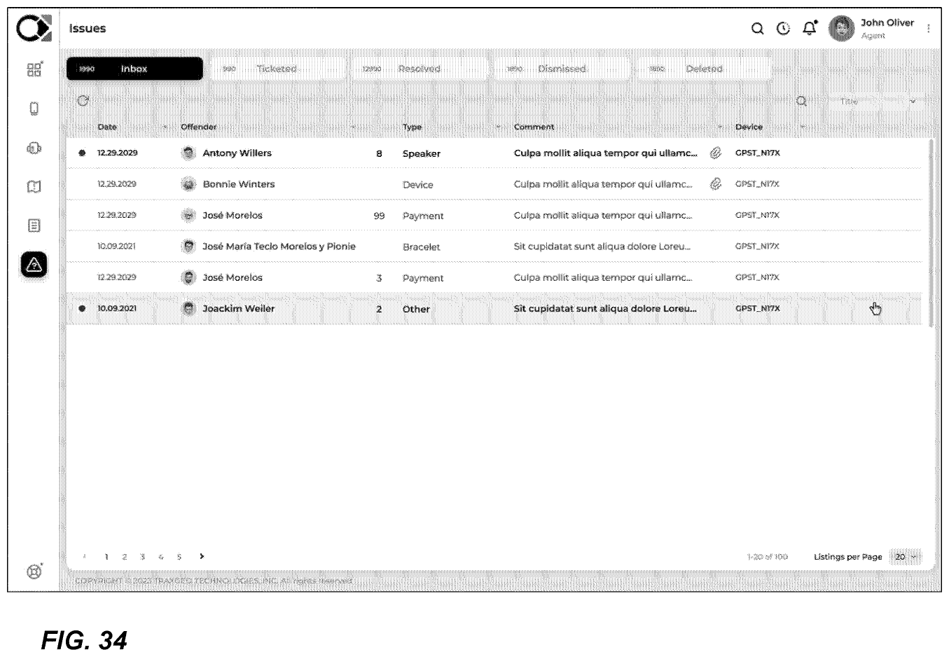

In a further example of an interface implemented by the web application on the tracking server and illustrated in FIG. 34, the agent can be shown issues associated with the ankle monitor devices applied to various individuals. For example, the issues can include problems with the device functionality, charge status, tampering status, or payment issues.

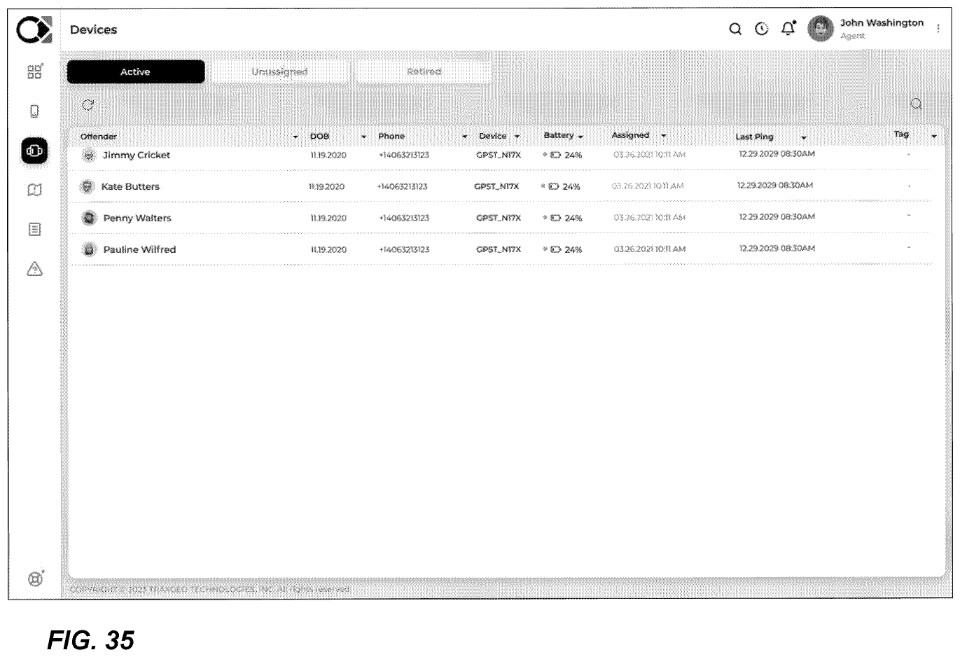

As illustrated in FIG. 35, the web application can further provide a listing of active devices including information about the alleged offender to which the device has been attached. Such an interface can provide additional data such as batteries status, phone number associated with the individual to which the device is attached, and other identifying information associated with the individual.

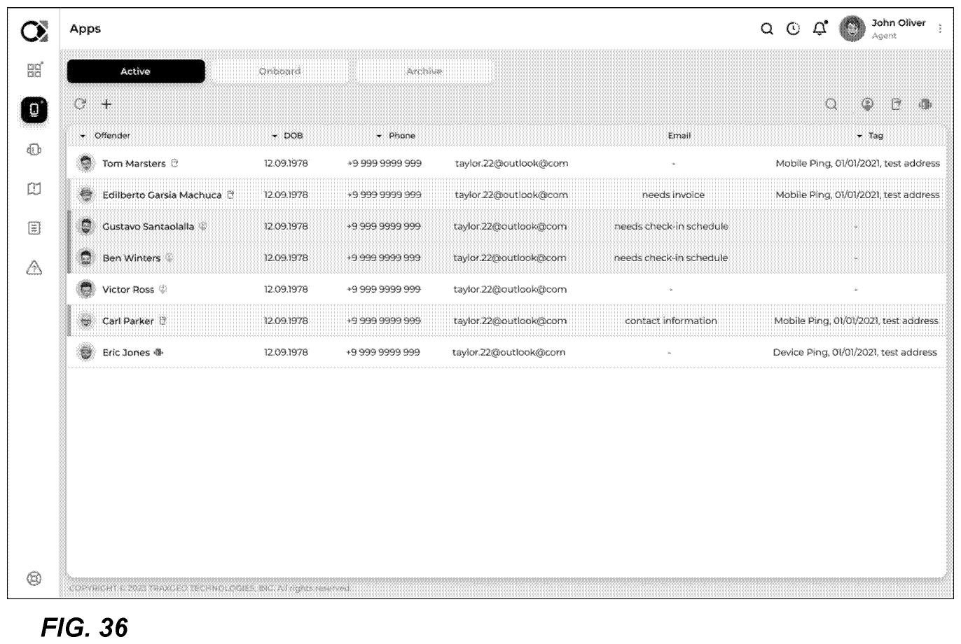

As illustrated in FIG. 36, an interface can be provided to the agent that identifies which individuals also have or separately have a smartphone application implementing tracking. The interface can include information about the user, the phone number, associated email address, or additional contact information, as well as status of the application.

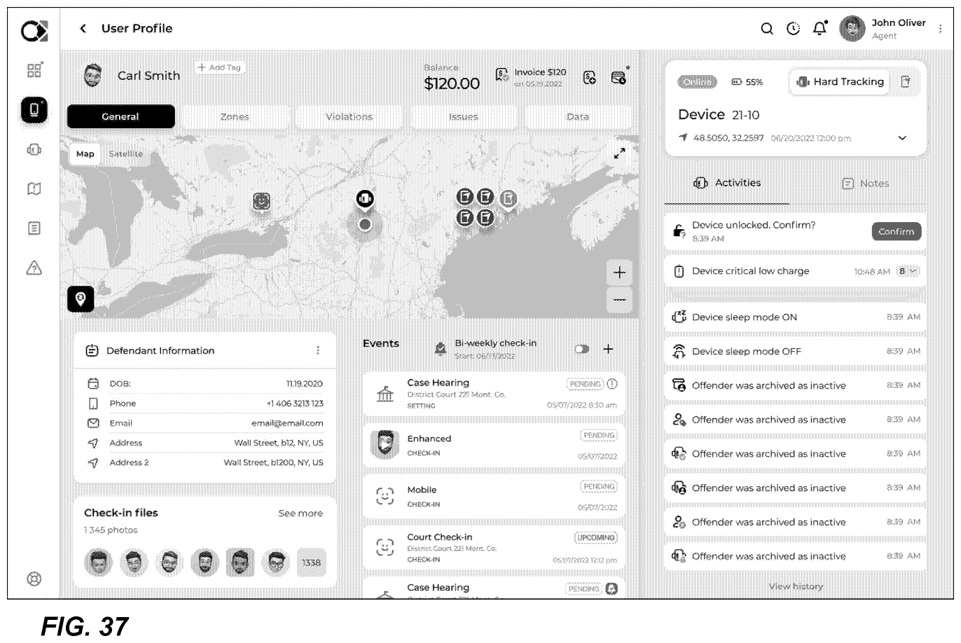

As illustrated in FIG. 37, the agent can further drill down to look at information about a specific user who may be a user of the smartphone application, the electronic ankle monitor, or both. The interface can provide specific information about events associated with that user, as well as tracking information associated with the electronic ankle monitor, the smartphone application, or a combination thereof. The interface can further require that any unlocking of a device is confirmed by the agent and provide the agent additional alerts specific to the individual, such as the status of the charge, in which mode the device is in, and if the offender violated a geographical boundary.

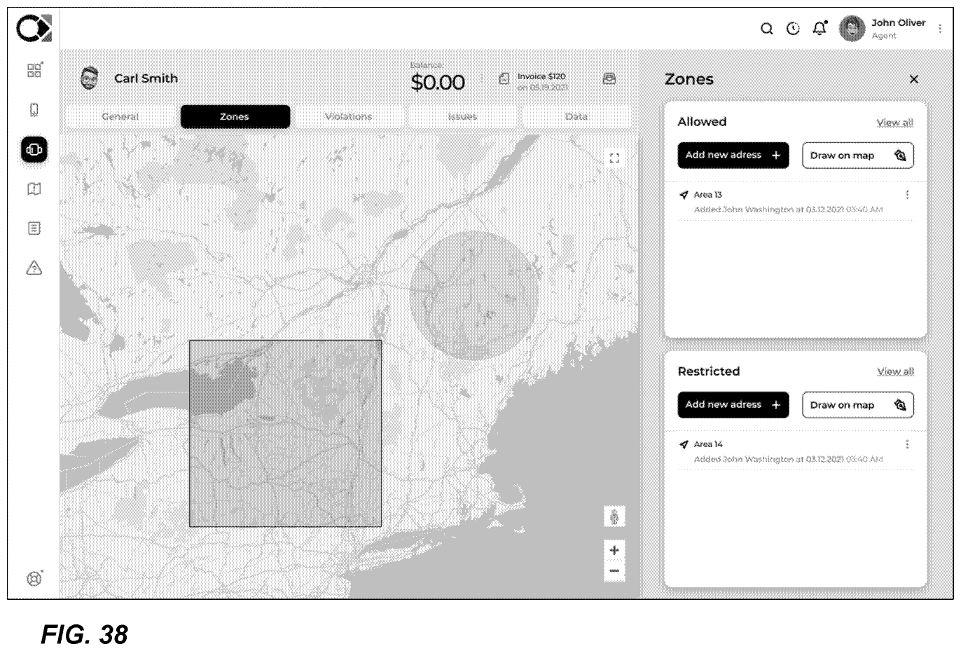

As illustrated in FIG. 38, the web application implemented on the tracking server can permit the establishment of zones. In an example, the zones can be based on the radius from a set location or can be rectilinear associating regions of the city. The boundaries may indicate regions where the wearer is allowed to be or regions where the wearer is not allowed to be. For example, the wearer may be provided with a region in which they are allowed to be at home or at work. In another example, there may be established sets of geographic boundaries where the wearer is not allowed to be. In the example illustrated in FIG. 38, the agent is provided options of applying a new address and a radius around that address where the person is allowed or drawing on a map where the person is allowed. Similarly, the interface provides the ability to add addresses or regions on a map to which the individual is restricted.

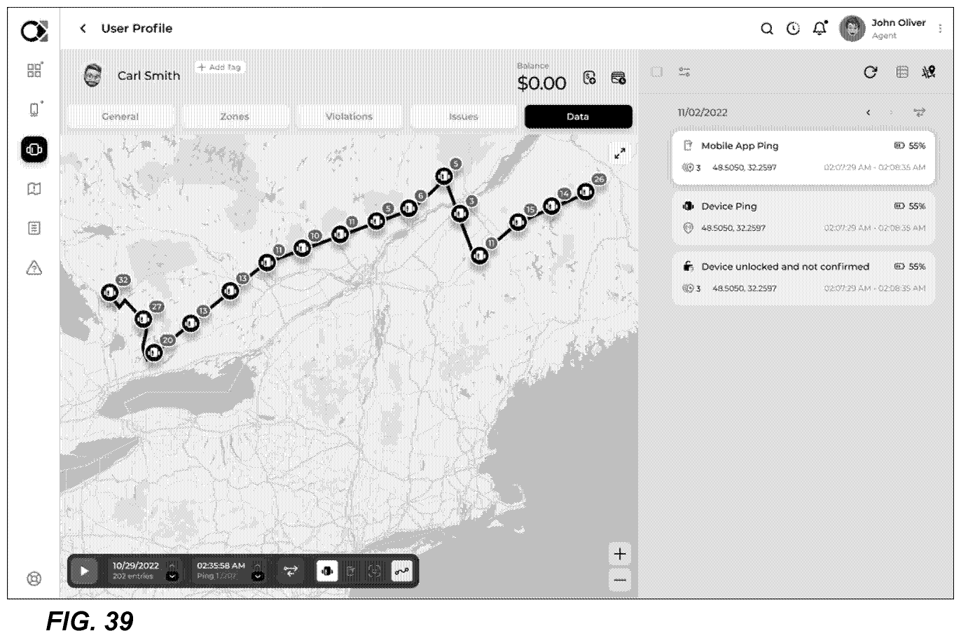

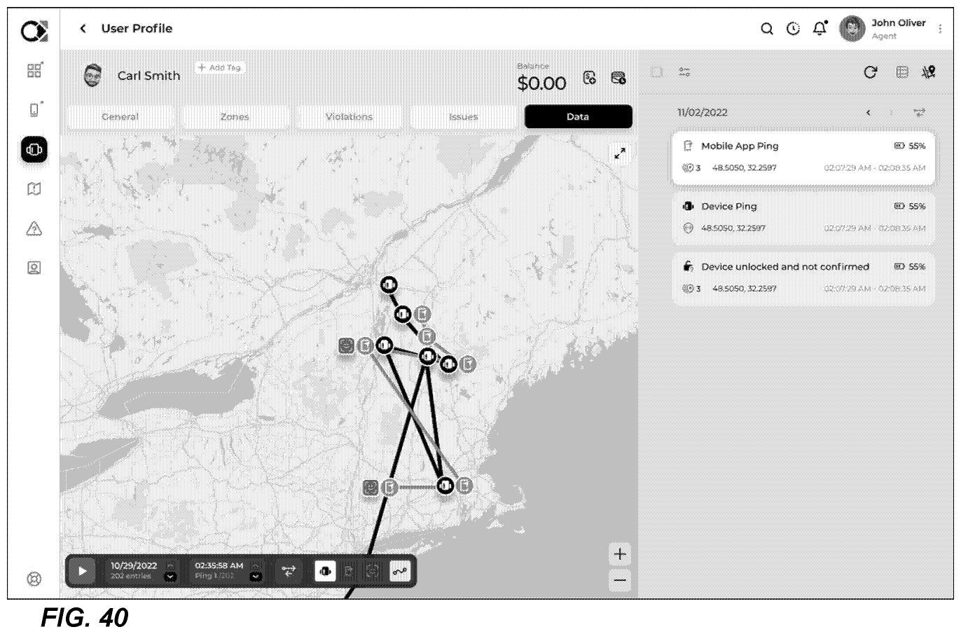

In an example, zones or regions can be uploaded to the electronic ankle monitor. The electronic ankle monitor using its location circuitry can determine whether the wearer is violating a boundary. For example, if a cellular data access or a GPS connection is lost, the electronic ankle monitor can continue to monitor location based on accelerometers and compare the estimated location with the boundaries provided through the web application on the tracking server. As illustrated in FIG. 39, the web application can further allow the agent to track the location of the electronic ankle monitor on a map. Optionally, as illustrated in FIG. 40, the agent can track both the location of the ankle monitor and the location of the smartphone implementing the smartphone application associated with the wearer of the electronic ankle monitor. In such an example, if the user or individual is required to perform electronic check-in using the smartphone application, the agent can compare the location of the smartphone used to perform the check-in with the location of the ankle monitor.

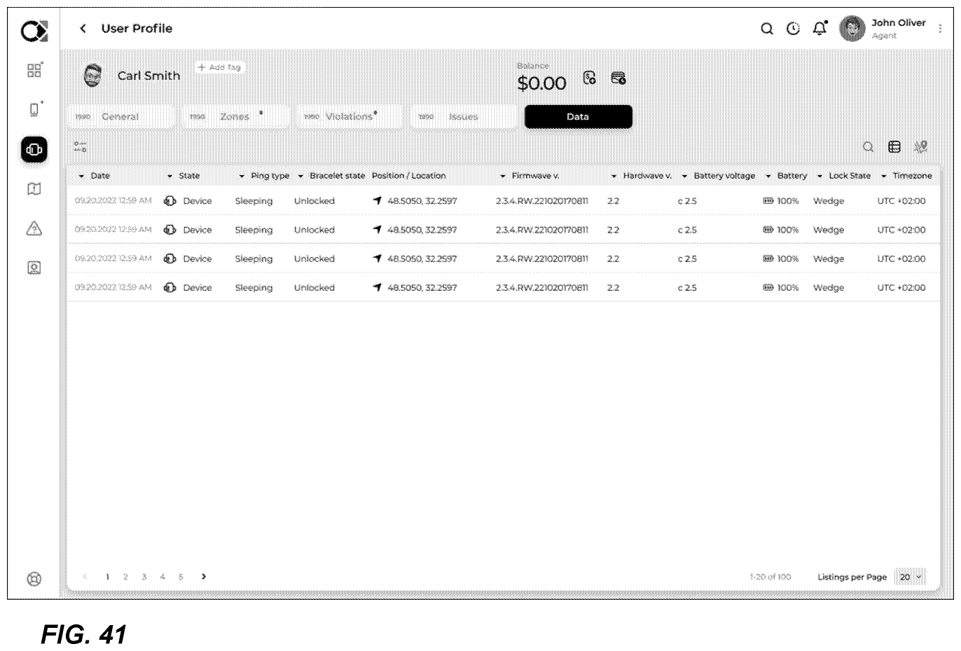

As illustrated in FIG. 39 and FIG. 40, the locations can be shown on a map. The location can further be shown in a table, as illustrated in FIG. 41 along with various other information about the device.

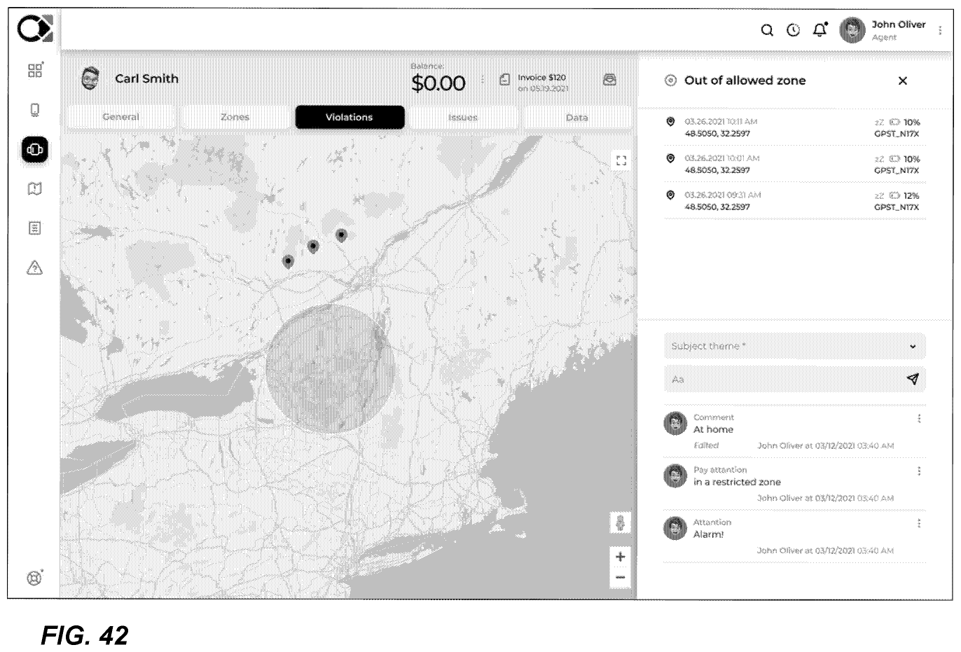

As illustrated in FIG. 42, the web application implemented on the tracking server can further notify the agent of violations of the set of geographical boundaries. For example, violations can be illustrated on a map showing the set of geographical boundaries and the location of the electronic ankle monitor. Depending on the nature of the violation, the agent can report the issue to an authority, contact the individual wearing the electronic ankle monitor, or send alerts to the smart phone application or the electronic medical monitor.

Wearers of the electronic ankle monitor can have a smartphone with a smartphone application. The smartphone application can be utilized to require check-in either randomly or in association with certain events, update account information such as making payments, and reporting issues with the device.

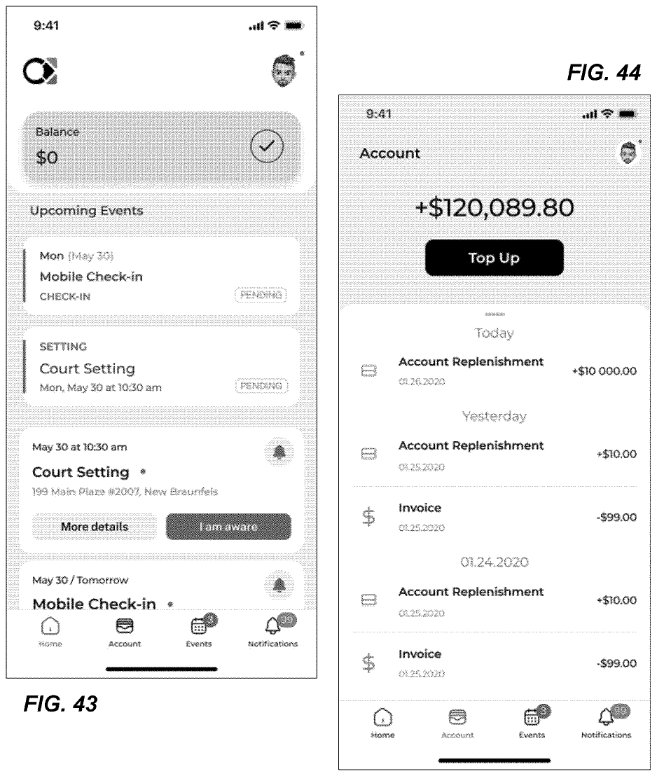

For example, FIG. 43 illustrates an exemplary dashboard on a smart phone application associated with someone being tracked either using the smartphone application or using an electronic ankle monitor. The dashboard can, for example, indicate a balance due for the individual, as well as upcoming events such as periodic check-ins and court dates.

As illustrated at FIG. 44, the individual can make payments towards an account, such as bail account, rental of the electronic ankle monitor, or payment for monitoring services.

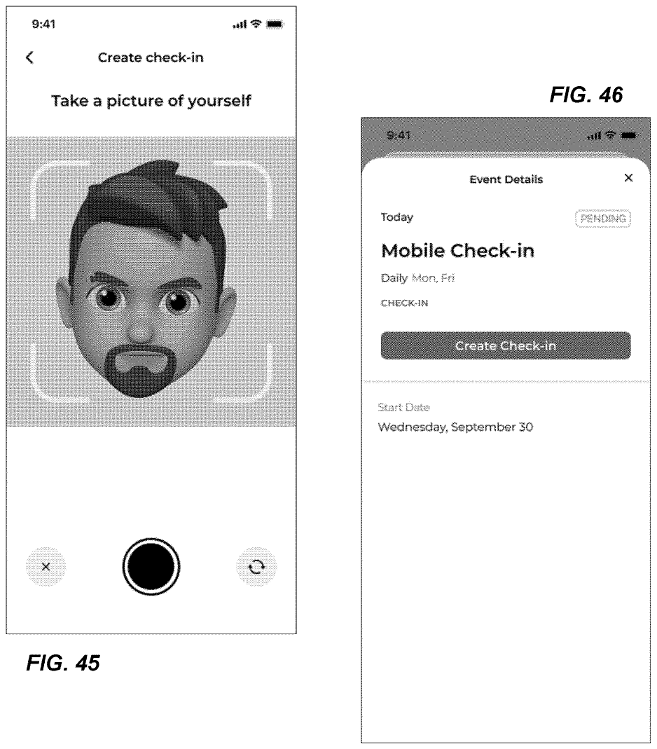

In a particular example, the smartphone application can be used to require an individual to check-in. Checking-in can include selecting a button to indicate a check-in, which provides location information of the smartphone application or smartphone or the electronic ankle monitor. In an example illustrated in FIG. 45, an individual can take a picture of themselves to confirm that they are at the same location as the smartphone or the electronic ankle monitor. Optionally, electronic facial recognition can be used to confirm that the individual is present in the same location as the smartphone or the ankle monitor. As illustrated in FIG. 46, the system can then require periodic mobile check-ins in which the individual takes a picture and confirms their identity and that they are located in proximity to the smartphone or the electronic ankle monitor.

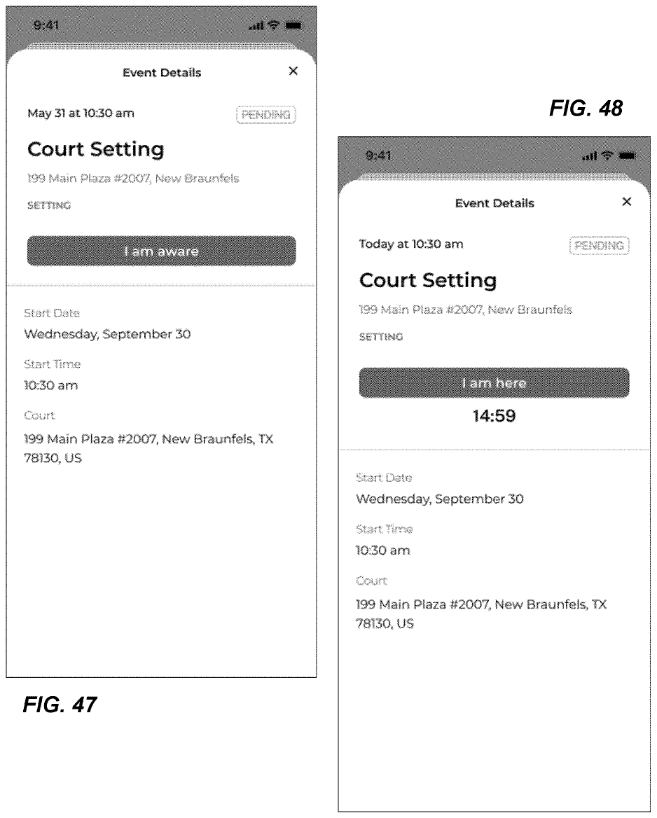

As illustrated in FIG. 47 and FIG. 48, the individual may also be required to confirm that they are aware of certain events and check-in at those events. For example, the individual can be provided with an interface illustrated in FIG. 47 in which they indicate that they are aware of an upcoming court date. In another example illustrated in FIG. 48, the individual can confirm that they are at a location; for example, they are in court. Optionally, the person may be required to take a photo to further confirm that they are, in fact, located in the same location as the smartphone or the ankle monitor bracelet.

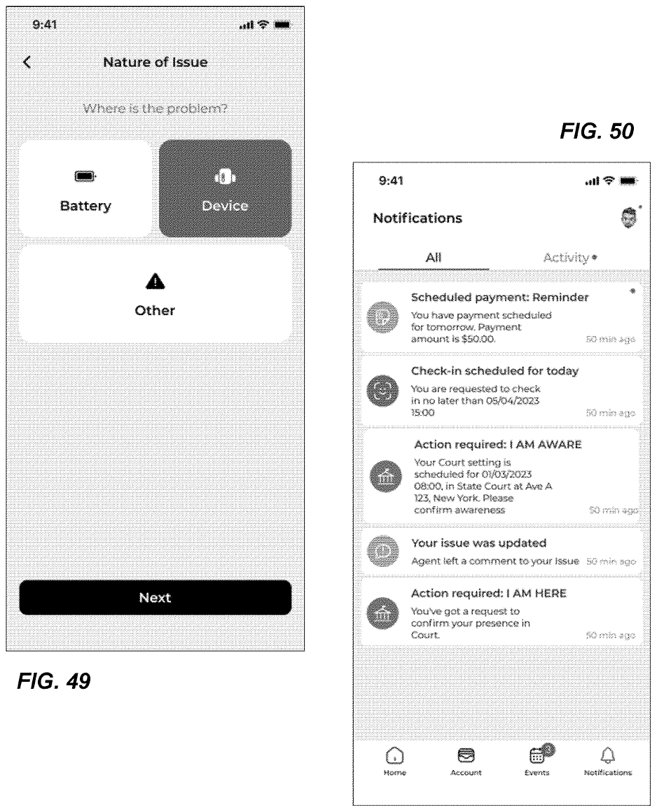

The smartphone application can further provide the world with the ability to report issues with the device itself or with comfort. For example, as illustrated in FIG. 49, an interface can be provided that allows the individual to indicate whether they have issues with the battery, issues with the functionality of the device, or other issues.

The smartphone application can further provide notifications to the user such as a listing of various activities including scheduling payments, checking-in, acknowledging court dates, and boundary violations, as illustrated in FIG. 50.

In a first embodiment, an ankle monitoring device includes a base that houses computational circuitry; communication circuitry in communication with the computational circuitry, the communication circuitry including a cellular data network circuitry; location circuitry in communication with computational circuitry, the location circuitry including global positioning system (GPS) circuitry and one or more accelerometers; and a detection circuitry in communication with the computational circuitry. The ankle monitoring device further includes a strap to engage the base and in electrical communication with the detection circuitry.

In an example of the first embodiment, the strap includes embedded circuit with a set resistance, the detection circuitry to detect tampering based on a change in resistance from the set resistance.

In another example of the first embodiment and the above examples, to engage the base, the strap includes a locking pin. For example, the ankle monitor device further includes a locking mechanism including a motor to turn a lock nut to engage the locking pin. In another example, the locking pin is in communication with the embedded circuitry of the strap and when engaged with the lock nut is secured against a pogo pin of the detection circuitry. In an additional example, the ankle monitor device further includes a second locking pin. For example, the ankle monitor device further includes a fixed locking screw to secure the second locking pin to the base. In an example, the second locking pin is secured against a pogo pin of the detection circuitry when secured with the fixed locking screw.

In a further example of the first embodiment and the above examples, the ankle monitor device further includes auditory circuitry in communication with the computation circuitry to provide audible alerts to a wearer of the ankle monitor.

In an additional example of the first embodiment and the above examples, the ankle monitor device further includes visual circuitry in communication with the computation circuitry to provide visual alerts to a wearer of the ankle monitor.

In another example of the first embodiment and the above examples, the ankle monitor device further comprises a wired electronic interface. For example, the ankle monitor device further includes a detachable interface to engage and communicate with the wired electronic interface. In an example, the detachable interface and the wired electronic interface are secured together using a magnet. In another example, the detachable interface includes a USB port, a Thunderbolt™ port, or a Firewire™ port.

In a further example of the first embodiment and the above examples, the communication circuitry further includes Bluetooth circuitry.

In an additional example of the first embodiment and the above examples, the ankle monitor device further includes a kinetic circuitry to provide alerts using vibration.

In a second embodiment, a tracking system includes a tracking server in communication with a network in communication with a cellular data network and an electronic ankle monitor. The electronic ankle monitor includes a base that houses computational circuitry; communication circuitry in communication with the computational circuitry, the communication circuitry in communication with the tracking server through the cellular data network; location circuitry in communication with computational circuitry, the location circuitry including global positioning system (GPS) circuitry and one or more accelerometers; and a detection circuitry in communication with the computational circuitry; and includes a strap to engage the base and in electrical communication with the detection circuitry. The tracking server is in communication with a smartphone application implemented on a smartphone via the cellular data network, the smartphone application associated with a wearer of the electronic ankle monitor.

In an example of the second embodiment, the tracking server is in communication with a second smartphone application implemented on a second smartphone via the cellular data network.

In another example of the second embodiment and the above examples, the second smartphone is associated with a victim.

In a further example of the second embodiment and the above examples, the second smartphone is associated with law enforcement.

In an additional example of the second embodiment and the above examples, the strap includes embedded circuit with a set resistance, the detection circuitry to detect tampering based on a change in resistance from the set resistance.

In another example of the second embodiment and the above examples, to engage the base, the strap includes a locking pin. For example, the tracking system further includes a locking mechanism including a motor to turn a lock nut to engage the locking pin. In an example, the locking pin is in communication with the embedded circuitry of the strap and when engaged with the lock nut is secured against a pogo pin of the detection circuitry. In another example, the locking mechanism is activated based on a signal from the tracking server. In a further example, the tracking system further includes a second locking pin. For example, the tracking system further includes a fixed locking screw to secure the second locking pin to the base. In an example, the second locking pin is secured against a pogo pin of the tamper circuitry when secured with the fixed locking screw.

In a further example of the second embodiment and the above examples, the tracking system further includes auditory circuitry in communication with the computation circuitry to provide audible alerts to a wearer of the ankle monitor.

In an additional example of the second embodiment and the above examples, the tracking system further includes visual circuitry in communication with the computation circuitry to provide visual alerts to a wearer of the ankle monitor.

In another example of the second embodiment and the above examples, the tracking system further includes a wired electronic interface. For example, the tracking system further includes a detachable interface to engage and communicate with the wired electronic interface. In an example, the detachable interface and the wired electronic interface are secured together using a magnet. For example, the detachable interface includes a USB port, a Thunderbolt™ port, or a Firewire™ port.

In a further example of the second embodiment and the above examples, the communication circuitry further includes Bluetooth circuitry.

In a third embodiment, a method of tracking an individual using an electronic ankle monitor includes determining a location with a location circuitry using a combination of global positioning system signals and accelerometer signals; comparing, using an ankle monitor computational circuitry, the location to a set of geographical boundaries stored on the ankle monitor; and alerting the individual of a violation of a boundary based at least in part on the comparing.

In an example of the third embodiment, the method further includes communicating the location to a tracking server via a cellular data network.

In another example of the third embodiment and the above examples, the method further includes storing the location on the electronic ankle monitor.

In a further example of the third embodiment and the above examples, the method further includes receiving the set of geographical boundaries from a tracking server.

In an additional example of the third embodiment and the above examples, the method further includes associating a smartphone with the electronic ankle monitor using a smartphone application implemented on the smartphone.

In another example of the third embodiment and the above examples, alerting the individual includes sending a signal to the smartphone and providing an alert via the smartphone application.

In a further example of the third embodiment and the above examples, alerting the individual includes providing an auditory alert using the electronic ankle monitor.

In an additional example of the third embodiment and the above examples, alerting the individual includes providing a visual alert using the electronic ankle monitor.

In another example of the third embodiment and the above examples, alerting the individual includes providing a kinetic alert using the electronic ankle monitor.

In a further example of the third embodiment and the above examples, the method further includes providing a user check-in interface with a smartphone application associated with the individual. For example, the user check-in interface utilized facial recognition.

In an additional example, the method further includes sending a locking signal to the electronic ankle monitor, a locking mechanism securing a strap to a base of the electronic ankle monitor. For example, the method further includes communicating a lock status from the electronic ankle monitor to a tracking server.

In a fourth embodiment, a method for tracking an individual includes establish communication between smartphone application and tracking server; communicate a location of the smartphone to the tracking server; and randomly requiring the individual to perform a check-in utilizing facial recognition through the smartphone application.

In an example of the fourth embodiment, the method further includes requiring the individual to perform a check-in through the smartphone application for a court appearance.

In another example of the fourth embodiment and the above examples, the method further includes associating the individual with an ankle monitor and associating the ankle monitor with the smartphone application. For example, the method further includes providing data from the ankle monitor to the smartphone application. In another example, the method further includes providing boundary violation alerts through the smartphone application based on the data provided from the ankle monitor.

In a fifth embodiment, a personal tracking device includes circuitry that includes a processor, memory, location circuity, wireless and/or wired communication circuitry, power supply, user interface; a housing that incorporates the circuitry; and a strap with an integrated locking mechanism that couples to the housing.

In a sixth embodiment, a method to make a personal tracking device includes providing circuitry that includes a processor, memory, location circuity, wireless and/or wired communication circuitry, power supply, user interface; providing a housing that incorporates the circuitry; and providing a strap with an integrated locking mechanism that couples to the housing.

In a seventh embodiment, a method to use a personal tracking device includes using circuitry that includes a processor, memory, location circuity, wireless and/or wired communication circuitry, power supply, user interface; providing a housing that incorporates the circuitry; and providing a strap with an integrated locking mechanism that couples to the housing.

In an eighth embodiment, a non-transitory program storage device readable by a computing device that tangibly embodies a program of instructions executable by the computing device to perform a method to use a personal tracking device including using circuitry that includes a processor, memory, location circuity, wireless and/or wired communication circuitry, power supply, user interface; providing a housing that incorporates the circuitry; and providing a strap with an integrated locking mechanism that couples to the housing.

In a ninth embodiment, a personal tracking device includes means for using circuitry for a personal tracking device; providing a housing that incorporates the circuitry means; and providing a strap with an integrated locking mechanism that couples to the housing.

In a tenth embodiment, a system for a personal tracking device includes a personal tracking device in communication with one or more tracking servers; where the personal tracking device can determine its location and status and communicate both to the tracking servers; where the personal tracking device includes circuitry that includes a processor, memory, location circuity, wireless and/or wired communication circuitry, power supply, user interface; a housing that incorporates the circuitry; and a strap with an integrated locking mechanism that couples to the housing.

In an eleventh embodiment, a method to make a system for a personal tracking device includes providing a personal tracking device in communication with one or more tracking servers; where the personal tracking device can determine its location and status and communicate both to the tracking servers; where the personal tracking device includes circuitry that includes a processor, memory, location circuity, wireless and/or wired communication circuitry, power supply, user interface; a housing that incorporates the circuitry; and a strap with an integrated locking mechanism that couples to the housing.

In an twelfth embodiment, a method to use a system for a personal tracking device includes using a personal tracking device in communication with one or more tracking servers; where the personal tracking device can determine its location and status and communicate both to the tracking servers; where the personal tracking device includes circuitry that includes a processor, memory, location circuity, wireless and/or wired communication circuitry, power supply, user interface; a housing that incorporates the circuitry; and a strap with an integrated locking mechanism that couples to the housing.

In a thirteenth embodiment, a non-transitory program storage device readable by a computing device that tangibly embodies a program of instructions executable by the computing device to perform a method to use a system for a personal tracking device including using a personal tracking device in communication with one or more tracking servers; where the personal tracking device can determine its location and status and communicate both to the tracking servers; where the personal tracking device includes circuitry that includes a processor, memory, location circuity, wireless and/or wired communication circuitry, power supply, user interface; a housing that incorporates the circuitry; and a strap with an integrated locking mechanism that couples to the housing.

In a fourteenth embodiment, a system for a personal tracking device includes a personal tracking device in communication with one or more tracking servers; where the personal tracking device can determine its location and status and communicate both to the tracking servers; where the personal tracking device includes means for using circuitry for a personal tracking device; a housing that incorporates the circuitry; and a strap with an integrated locking mechanism that couples to the housing.

While the present disclosure has been described in this disclosure regarding certain illustrated and described embodiments, those of ordinary skill in the art will recognize and appreciate that the present disclosure is not so limited. Rather, many additions, deletions, and modifications to the illustrated and described embodiments may be made without departing from the true scope of the invention, its spirit, or its essential characteristics as claimed along with their legal equivalents. In addition, features from one embodiment may be combined with features of another embodiment while still being encompassed within the scope of the invention as contemplated by the inventor. The described embodiments are to be considered only as illustrative and not restrictive. All changes which come within the meaning and range of equivalency of the claims are to be embraced within their scope. Disclosing the present invention is exemplary only, with the true scope of the present invention being determined by the included claims.

1. An ankle monitoring device comprising:
a base that houses:
computational circuitry;
communication circuitry in communication with the computational circuitry, the communication circuitry including a cellular data network circuitry;
location circuitry in communication with computational circuitry, the location circuitry including global positioning system (GPS) circuitry and one or more accelerometers; and
a detection circuitry in communication with the computational circuitry
a locking mechanism including a motor to turn a lock nut to engage the locking pin; and
a strap to engage the base and in electrical communication with the detection circuitry, wherein to engage the base, the strap includes a locking pin, the locking pin in communication with the embedded circuitry of the strap and when engaged with the lock nut is secured against a pogo pin of the detection circuitry.

2. The ankle monitor device of claim 1, wherein the strap includes embedded circuit with a set resistance, the detection circuitry to detect tampering based on a change in resistance from the set resistance.

3. (canceled)

4. (canceled)

5. (canceled)

6. The ankle monitor device of claim 1, further including a second locking pin.

7. The ankle monitor device of claim 6, further including a fixed locking screw to secure the second locking pin to the base.

8. The ankle monitor device of claim 7, wherein the second locking pin is secured against a pogo pin of the detection circuitry when secured with the fixed locking screw.

9. The ankle monitor device of claim 1, further comprising auditory circuitry in communication with the computation circuitry to provide audible alerts to a wearer of the ankle monitor.

10. The ankle monitor device of claim 1, further comprising visual circuitry in communication with the computation circuitry to provide visual alerts to a wearer of the ankle monitor.

11. The ankle monitor device of claim 1, further comprising a wired electronic interface.

12. The ankle monitor device of claim 11, further comprising a detachable interface to engage and communicate with the wired electronic interface.

13. The ankle monitor device of claim 12, wherein the detachable interface and the wired electronic interface are secured together using a magnet.

14. (canceled)

15. The ankle monitor device of claim 1, wherein the communication circuitry further includes Bluetooth circuitry.

16. The ankle monitor device of claim 1, further comprising a kinetic circuitry to provide alerts using vibration.

17. A tracking system comprising:
a tracking server in communication with a network in communication with a cellular data network;
an electronic ankle monitor including:
a base that houses:
computational circuitry;
communication circuitry in communication with the computational circuitry, the communication circuitry in communication with the tracking server through the cellular data network;
location circuitry in communication with computational circuitry, the location circuitry including global positioning system (GPS) circuitry and one or more accelerometers;
a detection circuitry in communication with the computational circuitry; and
a locking mechanism including a motor to turn a lock nut to engage the locking pin; and
a strap to engage the base and in electrical communication with the detection circuitry, wherein to engage the base, the strap includes a locking pin, the locking pin in communication with the embedded circuitry of the strap and when engaged with the lock nut is secured against a pogo pin of the detection circuitry; and
wherein the tracking server is in communication with a smartphone application implemented on a smartphone via the cellular data network, the smartphone application associated with a wearer of the electronic ankle monitor.

18. The tracking system of claim 17, wherein the tracking server is in communication with a second smartphone application implemented on a second smartphone via the cellular data network.

19. The tracking system of claim 18, wherein the second smartphone is associated with a victim.

20. The tracking system of claim 18, wherein the second smartphone is associated with law enforcement.

21. The tracking system of claim 17, wherein the strap includes embedded circuit with a set resistance, the detection circuitry to detect tampering based on a change in resistance from the set resistance.

22. (canceled)

23. (canceled)

24. (canceled)

25. The tracking system of claim 17, wherein the locking mechanism is activated based on a signal from the tracking server.

26. The tracking system of claim 17, further including a second locking pin.

27. The tracking system of claim 26, further including a fixed locking screw to secure the second locking pin to the base, wherein the second locking pin is secured against a pogo pin of the tamper circuitry when secured with the fixed locking screw.

28-83. (canceled)
